(19) United States
(12) Patent Application Publication
(10) Pub. No.: US 2008/0139803 A1
(43) Pub. Date: Jun. 12, 2008

(54) Cellulose Acylate Film and Method for Saponification Thereof

(75) Inventor: Yasuyuki Sasada, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/793,297

(22) PCT Filed: Dec. 22, 2005
(86) PCT No.: PCT/JP2005/023591

§ 371 Date: Jun. 14, 2007

(30) Foreign Application Priority Data
Jan. 5, 2005 (JP) 2005-000868

(51) Int. Cl. C08B 13/00

(52) U.S. Cl. 536/58

(57) ABSTRACT

A cellulose acylate film, wherein at least one surface thereof has a contact angle of water of less than 55°, and wherein all or a part of hydroxyl groups of cellulose is substituted for an acyl group having 3 or more carbon atoms. The cellulose acylate film has an excellent bonding property to a polarizer and a small fluctuation in retardation with a variation in humidity.

### TECHNICAL FIELD

The present invention relates to a cellulose acylate film which has an excellent bonding property to a polarizer and in which a fluctuation in retardation with a change in humidity is small, a polarizing plate, and a liquid crystal display device employing the cellulose acylate film with high reliability. In addition, the invention also relates to an alkaline saponification method of the cellulose acylate film.

### BACKGROUND ART

A cellulose acylate film is used in the support of a silver halide photographic sensitive material, a retardation plate, the support of the retardation plate, the protection film of a polarizing plate, and a liquid crystal display device, and is most commonly used in optical uses such as an image display device and the like. Since a cellulose acylate film has an appropriate moisture permeability, the cellulose acylate film can be directly bonded to a polarizer including polyvinyl alcohol as a main component by dipping the surface thereof in an alkaline aqueous solution so as to be saponified and hydrophilized as described in Patent Documents 1 to 4. For this reason, a cellulose acylate film is also used as the protecting film for a polarizer.

The polarizer adhering to the protecting film is incorporated in a liquid crystal display device with a liquid crystal cell at the time of manufacturing the liquid crystal display device. At this time, since the protecting film is disposed between the polarizer and the liquid crystal cell, the optical characteristic of the protecting film has an effect on a visibility of the liquid crystal display device. Accordingly, the protecting film is required to show a stable optical characteristic under an environmental variation such as a variation in humidity. However, there is a problem that retardation of the cellulose acylate film easily varies with a variation in humidity. Since improvement in retardation compensation in addition to a wide visual field angle and image quality improvement in the liquid crystal display device is more required in recent days, the cellulose acylate film is required to be improved.

In order to improve the stabilization against a variation in humidity, films of polycarbonate polymers or cycloolefin polymers which are more hydrophobic are proposed (i.e. see Patent Document 5). These films are available in the market as ZEONOR (produced by ZENON Corporation) or ARTON (produced by JSR Corporation). A variation with humidity has been improved in the films, but it is difficult for the films to be bonded to a polarizer including polyvinyl alcohol as a main component. Consequently, there is a need for further improvement of the films.

### Patent Document 1: JP-A-7-151914

### Patent Document 2: JP-A-8-94838

### Patent Document 3: JP-A-2001-166146

### Patent Document 4: JP-A-2001-188130

### Patent Document 5: JP-A-2001-318233

### DISCLOSURE OF THE INVENTION

As described above, in a film directly adhering to a polarizer, a bonding property to the polarizer and retardation stabilization against a variation in humidity have been in a trade-off relation.

Therefore, an object of the invention is to provide a cellulose acylate film which has an excellent bonding property to a polarizer and in which a fluctuation in retardation with a variation in humidity is small, a polarizing plate, and a liquid crystal display device employing the cellulose acylate film with high reliability. In addition, another object of the invention is to provide a cellulose acylate film having a low contact angle of water with the surface thereof.

As a result of extensive and intensive studies, the inventor has found out that the above-mentioned objects could by achieved by cellulose acylate films according to [1] to [8] and [20] described below, polarizing plates according to [9] to [11] described below, a liquid crystal display device according to [12] described below, and saponification methods according to [13] to [19] described below.

[1] A cellulose acylate film, wherein at least one surface thereof has a contact angle of water of less than 55°, and all or a part of hydroxyl groups of the cellulose is substituted for an acyl group having 3 or more carbon atoms.
[2] The cellulose acylate film according to [1], wherein all or a part of the hydroxyl groups of the cellulose is substituted for an acetyl group, a propionyl group, and/or a butyryl group.
[3] The cellulose acylate film according to [1] or [2], wherein a difference between a retardation in an in-plane direction (Re) measured at a relative humidity of 10% and a retardation in the in-plane direction (Re) measured at a relative humidity of 80% is 30 nm or less, and a difference between a retardation in a film thickness direction (Rth) measured at a relative humidity of 10% and a retardation in the film thickness direction (Rth) measured at a relative humidity of 80% is 30 nm or less.
[4] The cellulose acylate film according to any one of [1] to [3], wherein cellulose acylate satisfies Formula (1a):

0.5≦SP≦3.0 Formula (1a)

where SP represents a substitution degree of the hydroxyl group of cellulose for the propionyl group.
[5] The cellulose acylate film according to any one of [1] to [4], wherein the cellulose acylate satisfies Formula (2a):

0.5≦SB≦3.0 Formula (2a)

where SB represents a substitution degree of hydroxyl groups of the cellulose for a butyryl group.
[6] The cellulose acylate film according to any one of [1] to [5], wherein the cellulose acylate satisfies Formula (1b):

1.5≦SP≦3.0 Formula (1b)

where SP represents a substitution degree of hydroxyl groups of the cellulose for a propionyl group.
[7] The cellulose acylate film according to any one of [1] to [6], wherein the cellulose acylate satisfies Formula (2b):

1.0≦SB≦3.0 Formula (2b)

where SB represents a substitution degree of hydroxyl groups of the cellulose for a butyryl group.
[8] The cellulose acylate film according to any one of [1] to [7], which comprises a hydrophobic compound in an amount of 0 to 15% by mass with respect to the mass of polymers contained in the film.
[9] A polarizing plate comprising at least one sheet of the cellulose acylate film according to any one of [1] to [8].
[10] The polarizing plate according to [9], wherein the surface having a contact angle of water of less than 55° is bonded to a polarizer.
[11] The polarizing plate according to [9] or [10], wherein polarization degree is reduced by 0.1% or less after the polarizing plate is left at a temperature of 60° C. under a relative humidity of 90% for 1000 hours.
[12] A liquid crystal display device comprising at least one sheet of the cellulose acylate film according to any one of [1] to [8].
[13] A method for saponification of cellulose acylate film which comprises saponifying a cellulose acylate film satisfying Formulae (1a) and/or (2a) using an alkaline solution having a concentration of 3 mol/L or more as a saponifying solution:

0.5≦SP≦3.0 Formula (1a)

0.5≦SB≦3.0 Formula (2a)

where SP represents a substitution degree of hydroxyl groups of the cellulose for a propionyl group, and SB represents a substitution degree of hydroxyl groups of the cellulose for a butyryl group.
[14] The method for saponification of cellulose acylate film according to [13], wherein the saponification is conducted by dipping the cellulose acylate film in the saponifying solution which convects at a linear speed of 1 m/min or more.
[15] The method for saponification of cellulose acylate film according to [13] or [14], wherein a difference between a temperature of the saponifying solution at the beginning of the saponification of the cellulose acylate film and a temperature of the saponifying solution after completion of the saponification of the cellulose acylate film is 0.1° C. or more.
[16] The method for saponification of cellulose acylate film according to any one of [13] to [15], wherein the saponifying solution comprises an organic solvent.
[17] The method for saponification of cellulose acylate film according to [16], wherein the organic solvent is a glycol.
[18] The method for saponification of cellulose acylate film according to any one of [13] to [17], wherein the cellulose acylate film satisfies Formula (1a).
[19] The method for saponification of cellulose acylate film according to any one of [13] to [17], wherein the cellulose acylate film satisfies Formula (1b).
[20] A cellulose acylate film saponified by the method for saponification according to any one of [13] to [19].
[21] The cellulose acylate film according to any one of [1] to [8] and [20], which consists of a film formed by a melt-casting.
[22] The cellulose acylate film according to any one of [1] to [8] and [20], which consists of a film formed by a melt-casting with a touch roll.
[23] The cellulose acylate film according to any one of [1] to [8] and [20], wherein the amount of a remaining solvent is 0.01% by mass or less.
[24] The method for sponification of cellulose acylate film according to any one of [13] to [17], wherein the cellulose acylate film consists of a film formed by a melt-casting.
[25] The method for sponification of cellulose acylate film according to any one of [13] to [17], wherein the cellulose acylate film consists of a film formed by a melt-casting with a touch roll.
[26] The method for sponification of cellulose acylate film according to any one of [13] to [17], wherein the amount of a remaining solvent in the cellulose acylate film is 0.01% by mass or less.

In the cellulose acylate film according to the invention, since the contact angle of water with the surface thereof is small, a fluctuation in retardation with a variation in humidity is small. Accordingly, since the film can be bonded on-line to the polarizer including polyvinyl alcohol as a main component by using the cellulose acylate film according to the invention, it is possible to manufacture a polarizing plate and a liquid crystal display device having high reliability with high productivity. In addition, according to the saponification method of the invention, it is possible to easily obtain a cellulose acylate film having these excellent properties.

### BEST MODE FOR CARRYING OUT THE INVENTION

Hereinafter, the cellulose acylate film and the saponification method according to the invention will be described in detail. The constitution requirements to be described below are explained on the basis of the representative embodiment of the invention, but the invention is not limited to the embodiment. It should be noted that, in this specification, any notation using a word “to” indicates a range defined by values placed before and after such word, where both ends of such range are included as minimum and maximum values.

### [Contact Angle of Water]

The cellulose acylate film according to the invention is characterized in that a contact angle of water with the surface thereof is less than 55°. From the viewpoint of greatly hydrophilic bonding property to a polarizer, the contact angle of water is more preferably less than 50°, even more preferably less than 40°, and most preferably less than 30°. After a film is air conditioned at a temperature of 25° C. and a relative humidity of 60% for 3 hours or more, a drop of pure water having a diameter of 3 mm is dropped on the surface thereof, and thus a contact angle of water is obtained from the angle between a film surface and the drop of water.

For the cellulose acylate film according to the invention, the contact angle of water with at least one surface thereof is preferably less than 55°. Accordingly, a cellulose acylate film of which both surfaces have contact angles of water less than 55° is included in the scope of claim for patent of the invention.

### [Cellulose Acylate]

Cellulose acylate constituting the film according to the invention (hereinafter, referred to as “the cellulose acylate according to the invention”) will be described.

β-1,4 binding-glucose unit, which constitutes cellulose, has free hydroxyl groups on 2-, 3- and 6-positions. A cellulose acylate is a polymer in which all or a part of hydroxyl groups is esterified. In the specification, a substitution degree is used to show an esterification ratio of hydroxyl groups. A substitution degree is a total ratio of each esterified hydroxyl group on the 2-, 3- and 6-positions (the substitution degree is 1, when the hydroxyl groups are esterified at 100%). The substitution degree is 3 when all of the hydroxyl groups on the 2-, 3- and 6-positions are esterified.

An acyl group included in the cellulose acylate according to the invention may be an aliphatic acyl group or an aromatic acyl group. Preferable examples of the acyl group include an acyl group having carbon atoms in the range of 2 to 7, such as an acetyl group, a propionyl group, a butyryl group, a pentanoyl group, a hexanoyl group, a heptanoyl group, an isobutyryl group, a tert-butyryl group, a cyclohexane carbonyl group, a benzoyl group and the like. In these examples, more preferable examples are an acetyl group, a propionyl group, and a butyryl group.

The cellulose acylate according to the invention may be a mixed ester having plural kinds of esters in one molecule. Preferable examples of the mixed ester include cellulose acetate propionate, cellulose acetate butylate, cellulose propionate butylate, cellulose acetate hexanoate, cellulose acetate cyclohexanoate and the like. Preferable examples of the cellulose acylate include cellulose acetate propionate, cellulose propionate, cellulose acetate butylate, cellulose butylate, cellulose acetate propionate butylate and the like, and even more preferable examples of the cellulose acylate include cellulose acetate propionate, cellulose acetate butylate, cellulose acetate propionate butylate and the like.

It is preferable that the cellulose acylate according to the invention satisfies Formulae (1a) and/or (2a) when SP represents a substitution degree of hydroxyl groups of the cellulose for a propionyl group, and SB represents a substitution degree of hydroxyl groups of the cellulose for a butyryl group:

0.5≦SP≦3.0 Formula (1a)

0.5≦SB≦3.0 Formula (2a)

It is more preferable that the cellulose acylate according to the invention satisfies Formulae (1b) and/or (2b):

1.5≦SP≦3.0 Formula (1b)

1.0≦SB≦3.0 Formula (2b)

It is even more preferable that the cellulose acylate according to the invention satisfies Formulae (1c) and/or (2c).

2.0≦SP≦3.0 Formula (1c)

1.2≦SB≦2.0 Formula (2c)

### [Method of Preparing Cellulose Acylate]

Next, a method of preparing cellulose acylate according to the invention will be described.

A raw material cotton for the cellulose acylate according to the invention and a synthesizing method thereof are described in detail in Hatsumei Kyokai Disclosure Bulletin (No. 2001-1745, published by Hatsumei Kyokai, on Mar. 15, 2001) pages 7 to 12.

### (Raw Material for Cellulose Acylate and Pretreatment)

The raw material for cellulose is preferably originated from hardwood pulp, softwood pulp, and cotton linter. As the raw material for cellulose, it is preferable to use a high-purity material in which the content of α-cellulose is in the range of 92 to 99.9% by mass. In a case where the raw material for cellulose has a sheet form or a block form, it is preferable that the raw material for cellulose is dissolved in advance, and it is preferable that the dissolution continues until the form of cellulose is to be a feathery form from a powdery form.

### (Activation of Raw Material for Cellulose)

Before acylation, it is preferable that the raw material for cellulose is treated to be contacted to an activating agent (activation). It is possible to use a carboxylic acid or water as an activating agent. When water is used, a process of excessively adding an acid anhydride for dehydration, a process of washing with the carboxylic acid for the purpose of substituting water, or a process of adjusting conditions for acylation is preferably carried out after the activation. The activating agent may be added at any adjusted temperature, and may be added in a spray manner, a falling-drop manner, a dipping manner or the like, selectively.

Preferable examples of the carboxylic acid as an activating agent include a carboxylic acid having carbon atoms in the range of 2 to 7 (for example, acetic acid, propionic acid, butyric acid, 2-methylpropionic acid, valeric acid, 3-methylbutyric acid, 2-methylbutyric acid, 2,2-dimethylpropionic acid (pivalic acid), hexane acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptane acid, and cyclohexanecarboxylic acid, and benzoic acid), more preferable examples of the carboxylic acid include acetic acid, propionic acid, or butyric acid, and even more preferable example of the carboxylic acid includes acetic acid. At the time of activation, a bronsted acid such as a sulfuric acid may be also added as required. However, when a strong acid such as a sulfuric acid is added, depolymerization may be promoted. Accordingly, the strong acid is added in cellulose in a proportion of preferably 0.1 to 10% by mass. Two kinds or more of activating agents may be combined for use herein, or a carboxylic acid anhydride having carbon atoms in the range of 2 to 7 may be added.

The activating agent is added in cellulose in a proportion of preferably 5% by mass or more, more preferably 10% by mass or more, and even more preferably 30% by mass or more. A preferable content of the activating agent is 5% by mass or more, since troubles such as reduction in activation degree of cellulose do not occur. The upper limit of the content of the activating agent is not particularly limited so long as productivity is not lowered, but the activating agent is included in cellulose preferably in a proportion of 100 times or less, more preferably in a proportion of 20 times or less, and even more preferably in a proportion of 10 times or less in mass. The activating agent is excessively added to cellulose for activation, and then a process including filtration, air blowing and drying, heating and drying, distillation and removal under a reduced pressure, or solvent substitution is carried out to reduce the content of the activating agent.

Time for activation is preferably 20 minutes or more, and the upper limit thereof is not particularly limited so long as the upper limit has no effect on the productivity. However, the upper limit is preferably 72 hours or less, more preferably 24 hours or less, and even more preferably 12 hours or less. The activation temperature is preferably in the range of 0 to 90° C., more preferably in the range of 15 to 80° C., and even more preferably in the range of 20 to 60° C. The process of activating the cellulose may be carried out under a condition of pressurization or depressurization, and electromagnetic wave such as microwave and infrared radiation may be used as heating means.

### (Acylation of Cellulose)

In a method of preparing the cellulose acylate according to the invention, the carboxylic acid anhydride is preferably added to the cellulose and reacted using a lewis acid or the bronsted acid as a catalyst, and thus the hydroxyl groups of the cellulose are acylated. The synthesis of cellulose acylate having a large substitution degree on 6-position is described in JP-A-11-5851, JP-A-2002-212338, and JP-A-2002-338601.

As other synthesis methods of the cellulose acylate, a method of reacting the carboxylic acid anhydride or a carboxylic acid halide with the cellulose in the presence of a base (sodium hydroxide, potassium hydroxide, barium hydroxide, sodium carbonate, pyridine, triethylamine, tert-butoxypotassium, sodium methoxide, and sodium ethoxide) and a method of using a mixed acid anhydride (a mixed anhydride of carboxylic and trifluoroacetic acids and a mixed anhydride of carboxylic and methanesulfonic acids) as an acylating agent may be used. In particular, the latter method is available when an acyl group having a great number of carbon atoms or an acyl group having a difficulty to be applied in a liquid-state acylating method with a carboxylic acid anhydride-acetic acid-sulfuric acid catalyst is introduced.

For obtaining cellulose acylate according to the invention, for example, employable is a method of reacting cellulose with two kinds of carboxylic acid anhydrides both serving as an acylating agent, as their mixture or by successively adding them; a method of using a mixed acid anhydride of two kinds of carboxylic acids (i.e. mixed acetic/propionic acid anhydride); a method of reacting a carboxylic acid with a different carboxylic acid anhydride (e.g., acetic acid and propionic acid anhydride) in a reaction system to synthesize a mixed acid anhydride (i.e. mixed acetic/propionic acid anhydride) followed by further reacting it with cellulose; or a method of once preparing cellulose acylate having a degree of substitution of less than 3, and then further acylating it with an acid anhydride or an acid halide at its remaining hydroxyl group.

### (Acid Anhydride Used in Acylation)

For the carboxylic acid anhydride, the carboxylic acid preferably has carbon atoms in the range of 2 to 7. The carboxylic acid anhydride is preferably exemplified by acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentanecarboxylic anhydride, heptanoic anhydride, cyclohexanecarboxylic anhydride, benzoic anhydride or the like, more preferably exemplified by the acetic anhydride, the propionic anhydride, the butyric anhydride, the valeric anhydride, hexanoic anhydride, heptanoic anhydride or the like, and even more preferably exemplified by the acetic anhydride, the propionic anhydride, the butyric anhydride or the like.

For the purpose of preparing the cellulose acylate, these acid anhydrides are preferably combined for use herein. The mixing ratio thereof is preferably determined on the basis of the substitution ratio of the intended cellulose acylate. An excess equivalent of acid anhydrides is preferably added to the cellulose in general. In addition, the acid anhydride is preferably added to the cellulose in an amount of from 1.2 to 50 equivalents to the hydroxyl group of the cellulose, more preferably from 1.5 to 30 equivalents, even more preferably from 2 to 10 equivalents.

### (Catalyst for Acylation)

The bronsted acid or the lewis acid is preferably used as the catalyst for acylation used in the process of preparing the cellulose acylate according to the invention. The definitions for the bronsted acid and the lewis acid are described in, for example, “Dictionary of Physics and Chemistry”, 5th edition (2000). The bronsted acid is preferably exemplified by sulfuric acid, perchloric acid, phosphoric acid, methanesulfonic acid, benzenesulfonic acid, p-toluenesulfonic acid or the like. The lewis acid is preferably exemplified by zinc chloride, tin chloride, antimony chloride, magnesia chloride or the like. The sulfuric acid or the perchloric acid is preferably used as the catalyst, and even more preferable is the perchloric acid. In addition, its preferred amount to be added is in the range of 0.1 to 30% by mass, more preferably in the range of 1 to 15% by mass, even more preferably in the range of 3 to 12% by mass.

### (Solvent at the Time of Acylation)

A solvent may be added at the time of acylation for adjusting viscosity, reaction velocity, stirring property, acyl substation ratio, etc. While dichloromethane, chloroform, carboxylic acid, acetone, ethyl methyl ketone, toluene, dimethyl sulfoxide or sulfolane can, for example, be used as the solvent, carboxylic acid is preferred, including, for example, carboxylic acid having carbon atoms in the range of 2 to 7 {for example, acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methyl-valeric acid, 2,2-dimethylbutyric acid, 2,3-dimethylbutyric acid, 3,3-dimethylbutyric acid, cyclopentanecarboxylic acid or the like}. Acetic acid, propionic acid, butyric acid, etc. are more preferred, and a mixture of the catalysts also may be used.

### (Reaction Condition for Acylation)

Although the acylation may be carried out by mixing a mixture of an acid anhydride, a catalyst and a solvent, if required, with cellulose, or by mixing them one after another with cellulose, it is usually preferable to prepare a mixture of an acid anhydride and a catalyst, or a mixture of an acid anhydride, a catalyst and a solvent as an acylating agent and react it with cellulose. It is preferable to cool the acylating agent beforehand to restrain any temperature increase in the reaction vessel by the heat of the acylation reaction. It is preferably cooled to a temperature in the range of −50 to 20° C., more preferably in the range of −35 to 10° C., and even more preferably in the range of −25 to 5° C. The acylating agent may be added in a liquid state, or may be frozen and added in a solid state in crystal, flake or block form.

The acylating agent may be added to cellulose all at a time, or may be added thereto a plurality of times. Alternatively, cellulose may be added to the acylating agent all at a time, or may be added thereto a plurality of times. When the acylating agent is added a plurality of times, it is possible to use a single kind of acylating agent or a plurality of acylating agents differing from one another in composition. Preferred cases include 1) adding first a mixture of an acid anhydride and a solvent, and then a catalyst, 2) adding first a mixture of an acid anhydride, a solvent and a part of a catalyst, and then a mixture of the remaining catalyst and the solvent, 3) adding first a mixture of an acid anhydride and a solvent, and then a mixture of a catalyst and the solvent, and 4) adding first a solvent, and then a mixture of an acid anhydride and a catalyst, or a mixture of the acid anhydride, catalyst and solvent.

Although the acylation of cellulose is an exothermic reaction, it is preferable that a maximum temperature of 50° C. not be exceeded by acylation in the method of preparing the cellulose acylate according to the invention. The reaction temperature not exceeding that level is preferable for avoiding any inconvenience such as the progress of depolymerization making it difficult to obtain cellulose acylate having a polymerization degree suited for the purpose of the invention. The maximum temperature not to be exceeded by acylation is preferably 45° C., more preferably 40° C., and even more preferably 35° C. The reaction temperature may be controlled by using a temperature controller, or by controlling the initial temperature of the acylating agent. It is also possible to depressurize the reaction vessel and control the reaction temperature by the heat generated by the evaporation of the liquid component in the reaction system. It is also effective to employ cooling during the initial period of the reaction and heating thereafter, since the generation of heat by acylation is remarkable during the initial period of the reaction. The end point of acylation can be determined by means of light transmittance, solution viscosity, temperature variation in the reaction system, solubility of the reaction product in an organic solvent, observation through a polarizing microscope, etc.

The minimum temperature of the reaction is preferably −50° C. or more, more preferably −30° C. or more, and even more preferably −20° C. or more. Time for acylation is preferably in the range of 0.5 to 24 hours, more preferably in the range of 1 to 12 hours, and even more preferably in the range of 1.5 to 6 hours. When it is less than 0.5 hour, the reaction does not proceed satisfactorily under the usual reaction conditions, while no time exceeding 24 hours is desirable for industrial production.

### (Reaction Terminator for Acylation)

According to the method of preparing cellulose acylate used in the invention, the acylation reaction is preferably followed by the addition of a reaction terminator.

The reaction terminator may be anything that can decompose an acid anhydride, and preferred examples are water, alcohol (for example ethanol, methanol, propanol or isopropyl alcohol) or a composition containing them. When the reaction terminator is added, the addition of a mixture of a carboxylic acid such as acetic, propionic or butyric acid and water is preferable to the direct addition of water or alcohol for avoiding the generation of a large amount of heat exceeding the cooling capacity of the reaction apparatus and causing inconveniences, such as a reduction in the polymerization degree of cellulose acylate and any undesired sedimentation of cellulose acylate. Acetic acid is preferable to any other carboxylic acid. While any ratio of carboxylic acid to water can be employed, the proportion of water is preferably in the range of 5 to 80% by mass, more preferably in the range of 10 to 60% by mass, and even more preferably in the range of 15 to 50% by mass.

The reaction terminator may be added to the reaction vessel for acylation, or alternatively, the reaction mixture may be added to a vessel for the reaction terminator. The addition of the reaction terminator preferably takes from three minutes to three hours. Its addition taking 3 minutes or more is preferable for avoiding any inconvenience, such as the generation of so large an amount of heat as to cause reduction in the polymerization degree, insufficient hydrolysis of the acid anhydride or reduction in stability of cellulose acylate. Its addition not taking more than 3 hours is preferable for avoiding any problem, such as a reduction in industrial productivity. Its addition preferably takes from 4 minutes to 2 hours, more preferably from 5 minutes to 1 hour and even more preferably from 10 to 45 minutes. While the addition of the reaction terminator does not essentially require any cooling of the reaction vessel, its cooling is preferable for restraining any undesirable temperature increase and thereby any depolymerization. The reaction terminator is preferably cooled, too.

### (Reaction Neutralizing Agent at the Time of Acylation)

A neutralizing agent (for example, the carbonate, acetate, hydroxide or oxide of calcium, magnesium, iron, aluminum or zinc) or a solution thereof may be added after the step of terminating the acylation to hydrolyze any excessive carboxylic acid anhydride remaining in the system and neutralize all or a part of the acylation catalyst. Preferred examples of solvents for the neutralizing agent are water, alcohols (for example, ethanol, methanol, propanol and isopropyl alcohol), carboxylic acids (for example, acetic acid, propionic acid and butyric acid), ketones (for example, acetone and ethyl methyl ketone), dimethylsulfoxide and other polar solvents, and a mixture thereof.

### (Partial Hydrolysis of Cellulose Acylate)

As the cellulose acylate obtained as described above has a total substitution degree for hydroxyl groups of the cellulose of nearly 3, it is usual practice to hold it at a temperature in the range of 20 to 90° C. for several minutes to several days in the presence of a small amount of catalyst (usually an acylation catalyst, such as the remaining sulfuric acid) and water for hydrolyzing the ester bonds partially and changing the acyl substitution degree of cellulose acylate to a desired level (that is, aging it). As the process of the partial hydrolysis causes the hydrolysis of the sulfuric acid ester of cellulose, too, it is possible to reduce the amount of the sulfuric acid ester bonded to cellulose by controlling the conditions of the hydrolysis.

### (Termination of Partial Hydrolysis of Cellulose Acylate)

When the desired cellulose acylate has been obtained, it is preferable to neutralize the catalyst remaining in the system completely by using a neutralizing agent as described above or a solution thereof to terminate the partial hydrolysis. The addition of a neutralizing agent (for example, magnesium carbonate or magnesium acetate) forming a salt having a low solubility in the reacted solution is desirable for the effective removal of the catalyst (for example, sulfuric acid ester) in the solution or bonded to cellulose.

### (Filtration of Cellulose Acylate)

The reaction mixture after acylation is preferably subjected to filtration for removing or reducing any unreacted matter, sparingly soluble salt and any other foreign matter from the cellulose acylate. The filtration may be carried out at any process from the completion of acylation to reprecipitation. Its dilution with a suitable solvent prior to the filtration is preferable for controlling its filtration pressure and its ease of handling. At the time of filtration, the filtering media is not particularly limited, and its preferred examples are fabric, glass filter, cellulosic filter paper, cellulosic fabric filter, metallic filter, and polymeric filter (for example, polypropylene filter, polyethylene filter, polyamide filter, and fluorine filter). The filter diameter thereof is preferably in the range of 0.1 to 500 μm, more preferably in the range of 2 to 200 μm, and even more preferably in the range of 3 to 60 μm.

### (Reprecipitation of Cellulose Acylate)

The cellulose acylate solution as obtained is mixed in a poor solvent such as water or an aqueous solution of a carboxylic acid (e.g. acetic acid or propionic acid), or a poor solvent is mixed in the cellulose acylate reaction solution, so that cellulose acylate may be reprecipitated, and its washing and stabilization treatment give the intended cellulose acylate. The reprecipitation may be carried out continuously, or on a batch basis by increments. It is preferable to adjust the concentration of the cellulose acylate solution and the composition of the poor solvent by the mode of substitution of cellulose acylate or its polymerization degree to thereby control the form of the reprecipitated cellulose acylate and its molecular weight distribution.

In order to e.g. achieve an improved refining result and a controlled molecular weight distribution or apparent density, it is effective to dissolve the reprecipitated cellulose acylate again in its good solvent (for example, acetic acid or acetone) and react its solution with a poor solvent (for example, water) for reprecipitation, which operation may be repeated one or a plurality of times as required.

### (Washing of Cellulose Acylate)

The cellulose acylate as prepared is preferably washed. Any washing solvent may be used if it dissolves cellulose acylate and yet can remove impurities therefrom, though water or warm water is usually used. Washing water preferably has a temperature in the range of 5 to 100° C., more preferably in the range of 15 to 90° C., and even more preferably in the range of 30 to 80° C. Washing treatment may be performed on a batch basis by repeating the filtration and the exchange of the washing solution, or by using a continuous washing apparatus. The waste solution resulting from the reprecipitation process and washing process is preferably reused as a poor solvent for another reprecipitation process, or distilled or otherwise treated so that a solvent, such as carboxylic acid, may be recovered for reuse.

While any method can be used for checking the progress of washing, preferred examples thereof include hydrogen ion concentration, ion chromatography, electrical conductivity, ICP, elemental analysis and atomic absorption spectrum.

Such treatment makes it possible to remove the bronsted acid (such as sulfuric acid, perchloric acid, trifluoroacetic acid, p-toluenesulfonic acid, or methanesulfonic acid), the neutralizing agent (such as the carbonate, acetate, hydroxide or oxide of calcium, magnesium, iron, aluminum or zinc), the reaction product of the neutralizing agent and the catalyst, the carboxylic acid (such as acetic acid, propionic acid or butyric acid), the reaction product of the neutralizing agent and the carboxylic acid, etc. from cellulose acylate, and is, therefore, effective for increasing the stability of cellulose acylate (in particular, decomposition of an ester bond resulting from a high-temperature and humidity).

### (Stabilization)

The cellulose acylate which has been washed by warm water treatment is preferably treated with e.g. an aqueous solution of a weak alkali (for example, carbonate, hydrogen carbonate, hydroxide or oxide of sodium, potassium, calcium, magnesium or aluminum) in order to be further improved in stability, or remove any odor of carboxylic acid.

The amount of the remaining impurities can be controlled by the amount of the washing solution, washing temperature, washing time, a method of stirring, the shape of a washing container, and the composition and concentration of the stabilizing agent.

### (Drying)

The cellulose acylate according to the invention is preferably dried to have its water content adjusted to a desired level. While any drying method can be employed if it enables the intended water content to be obtained, it is preferable to perform drying treatment efficiently by using a method such as heating, air blowing, depressurization or stirring, or a combination thereof. Drying treatment is preferably performed at a temperature in the range of 0 to 200° C., more preferably in the range of 40 to 180° C., and even more preferably in the range of 50 to 160° C. At this time, the cellulose acylate is preferably dried at a temperature lower than a glass transition point (Tg) of the cellulose acylate, and more preferably at a temperature of (Tg-10)° C. or less.

The cellulose acylate according to the invention, which can be obtained by drying, preferably has a water content of 2% by mass or less, more preferably 1% by mass or less, and even more preferably 0.7% by mass or less.

### (Form)

When the cellulose acylate is used as a material for manufacturing a film, the cellulose acylate preferably has a particulate form or a powdery form. Cellulose acylate after drying may be crushed or sieved to have a uniform particle size and an improved property of handling. When cellulose acylate is particulate, at least 90% by mass or more of its particles which are used preferably have a particle size in the range of 0.5 to 5 mm. Moreover, at least 50% by mass or more of its particles which are used preferably have a particle size in the range of 1 to 4 mm. The cellulose acylate particles are preferably as close to spherical as possible in shape.

### (Polymerization Degree)

When cellulose ester is used for solution-casting film formation, the polymerization degree of cellulose acylate preferably used in the invention is preferably in the range of 150 to 500, more preferably in the range of 200 to 400, and even more preferably in the range of 220 to 350 in an average viscosity polymerization degree. When cellulose ester is used for melt-casting film formation, the polymerization degree is preferably in the range of 100 to 300, more preferably in the range of 120 to 250, and even more preferably in the range of 130 to 200 in an average viscosity polymerization degree. The average viscosity polymerization degree can be measured by limiting viscosity method of Uda et al (Kazuo UDA and Hideo SAITO, Journal of the Society of Fibers, Vol. 18, No. 1, pages 105 to 120, 1962). The method of measuring the average viscosity polymerization degree is disclosed in JP-A-9-95538.

### [Additive]

In the cellulose acylate film according to the invention, it is preferable that the amount of a hydrophobic additive to be added is large from the viewpoint of reduction in a fluctuation in retardation with a variation in humidity. However, Tg of a polymer film is easily reduced or additives easily volatilize in the film manufacturing process, as the additive amount increases. Accordingly, the hydrophobic additive is included in the cellulose acylate film according to the invention in a proportion of preferably 0 to 15% by mass, more preferably 3 to 10% by mass, and even more preferably 4 to 8% by mass.

Such hydrophobic additive is an organic compound which has a molecular weight of 3000 or less and a low solubility in water, and is exemplified by plasticizer, ultraviolet inhibitor, optical anisotropy controller, minute particles, remover, infrared absorber, retardation increasing agent or the like. It is preferable that the compounds have a high affinity for cellulose acylate and do not bleed-out in the film formation process. Specific examples of the compound are described in JP-A-2001-151901, JP-A-2001-194522, Hatsumei Kyokai Disclosure Bulletin No. 2001-1745 (published by Hatsumei Kyokai on Mar. 15, 2001) pages 16 to 22.

### [Cellulose Acylate Film]

The cellulose acylate film according to the invention may be formed of the above-described one kind of cellulose acylate, or also may be formed of a mixture of two kinds or more of cellulose acylate. In addition, a mixture in which cellulose acylate and other high molecular components are properly mixed may be used. The high molecular components as mixed are preferably excellent in compatibility with the cellulose acylate, and those transmittances at the time of forming a film of the high molecular components are preferably 80% by mass, more preferably 90% by mass, and even more preferably 92% by mass.

The film according to the invention, formed with the cellulose acylate and the additive, may be formed by a solution-casting film formation method, or by a melt-casting film formation method. The cellulose acylate solution-film formation is described in Hatsumei Kyokai Disclosure Bulletin No. 2001-1745 (published by Hatsumei Kyokai on Mar. 15, 2001), JP-A-2005-99097, JP-A-2005-104011, JP-A-2005-104148, JP-A-2005-104149, JP-A-2005-105066, JP-A-2005-138358, JP-A-2005-154631, JP-A-2005-219444, JP-A-2005-232328, JP-A-2005-232329, JP-A-2005-263941, JP-A-2005-272485, JP-A-2005-272800, JP-A-2005-330411, and the like. A solvent for the cellulose acylate solution-film formation may be a chlorine solvent and may be a non-chlorine solvent, and a dissolution method for the cellulose acylate solution-film formation may be any one of an ordinary-temperature dissolving method, a cooling dissolving method, and high-temperature dissolving method, or may be a method in which the above-mentioned methods are combined. The cellulose acylate melt-casting film formation is described in JP-A-2000-352620, JP-A-2005-178194, JP-A-2005-301225, and JP-A-2005-330411, Pamphlet of International Publication WO 2005/103122, and the like, and these methods may be appropriately employed. In addition, a touch roll film formation to be described later is preferably applied to the melt-casting film formation.

### (Touch Roll Film Formation)

In the invention, a touch roll is preferably used in forming a film on a casting drum, after a melt generated in dissolving treatment is extruded from a die. This method is performed in such a manner that the melt released from the die is sandwiched between the casting drum and the touch roll to be cooled and solidified. Since minute unevenness formed on a film can be even by using this method, blur in a liquid crystal display device can be reduced.

Such a touch roll preferably has an elastic property in order to reduce residual strain generated at the time of inserting the melt released from the die between rolls. In order to provide an elastic property to the roll, it is necessary for the thickness of the outer jacket of the roll to be thinner than the conventional rolls, and the thickness Z of the outer jacket is preferably in the range of 0.05 to 7.0 mm, more preferably in the range of 0.2 to 5.0 mm, and even more preferably in the range of 0.3 to 2.0 mm. For example, since the thickness of the outer jacket is to be thinner, the roll includes a type to which an elastic property is applied or an elastic layer formed on a metal shaft, which is further covered with the outer jacket and in which a liquid medium layer is filled between the elastic layer and the outer jacket. Accordingly, it is possible to form a film by the use of the touch roll since the thickness of the outer jacket is thin. It is preferable that the surface of touch roll and casting roll is a mirror plane, and an arithmetic average height Ra is preferably 100 nm or less, more preferably 50 nm or less, and even preferably 25 nm or less. In specific, ones disclosed in, for example, JP-A-11-314263, JP-A-2002-36332, JP-A-11-235747, JP-A-2004-216717, and JP-A-2003-145609, Pamphlet of International Publication WO 97/28950, or the like, can be used.

As mentioned, since the touch roll is filled with a fluid inside its thin outer jacket, it may be elastically deformed as depressed by the pressure applied thereto when kept in contact with a casting roll. Accordingly, since the touch roll and the casting roll are in face-to-face contact with each other, their pressure is dispersed and they may attain a low surface pressure. Therefore, no residual strain remains in the film sandwiched between them, and the surface unevenness of the film may be therefore removed. Preferably, the linear pressure of the touch roll is from 3 to 100 kg/cm, more preferably from 5 to 80 kg/cm, even more preferably from 7 to 60 kg/cm. The linear pressure as referred to herein means a value to be obtained by dividing the power given to the touch roll by the width of die orifice. When the linear pressure is 3 kg/cm or more, the minute unevenness caused by pressing of the touch roll can be effectively reduced. When the linear pressure is 100 kg/cm or less, the touch roll is hardly deformed, and easily and more evenly touches the melt over the entire casting roll, thereby effectively reducing the minute unevenness over the entire width.

The temperature of the touch roll is set preferably in the range of 60 to 160° C., more preferably in the range of 70 to 150° C., even more preferably in the range of 80 to 140° C. The temperature control within the range may be attained by making a conditioned liquid or vapor run inside the roll.

The film according to the invention may be stretched in a positive manner or may be not stretched, after the casting film formation.

### [Alkaline Solution]

The film according to the invention can be saponified. It is preferable that saponification is carried out by the use of an alkaline solution having a concentration of 3 mol/L or more as a saponifying solution according to saponification method of the invention. The saponifying solution is formed of alkaline agents and water, and may contain a surface active agent and a compatibilizer in some cases.

The concentration of the alkaline solution (the amount of the alkaline agent contained in the alkaline solution) is required to be determined in accordance with the acyl substitution degree of the cellulose acylate. That is, in the cellulose acylate, saponification efficiency is greatly lowered as the number of carbon atoms of the acyl group increases, whereby the more the number of carbon atoms of the acyl group increases, the higher the alkali concentration is required to be high. However, when the alkaline concentration is too high, the stabilization of the alkaline solution is deteriorated, and thus the alkaline agent may be deposited in an application for a long time. Accordingly, it is important to appropriately select the alkaline solution on the basis of the primary structure of the cellulose acylate. For the reason, the concentration of the alkaline solution used in the invention is preferably 3 mol/L or more, more preferably in the range of 3 to 15 mol/L, even more preferably in the range of 4 to 10 mol/L, and most preferably in the range of 5 to 8 mol/L. The concentration of the alkaline solution may be adjusted, in this range, in accordance with the kind of alkaline agent to be used, the reaction temperature, and the reaction time.

An alkaline agent is exemplified by an inorganic alkaline agent including tribasic sodium phosphate, tribasic potassium phosphate, tribasic ammonium phosphate, dibasic sodium phosphate, dibasic potassium phosphate, dibasic ammonium phosphate, ammonium bicarbonate, ammonium acid carbonate, sodium borate, potassium borate, ammonium borate, sodium hydroxide, potassium hydroxide, lithium hydroxide, ammonium hydroxide and the like. In addition, an organic alkaline agent including monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethylenimine, ethylenediamine, pyridine, DBU(1,8-diazabicyclo[5,4,0]-7-undecene), DBN(1,5-diazabicyclo[4,3,0]-5-nonane, tetramethylammoniumhydroxyd, tetraethylammoniumhydroxyd, tetrapropylammoniumhydroxyd, tetrabutylammoniumhydroxyd, triethylbutylammoniumhydroxyd and the like also may be used as an alkaline agent. These alkaline agents may be used alone, or in combination of two or more kinds, or, may be partially halogenated and added in the form of salt.

In these alkaline agents, sodium hydroxide and potassium hydroxide are preferable. The reason is that pH can be adjusted in a wide pH range by adjusting the amounts thereof.

The solvent for the alkaline solution is either water, or a mixed solvent of water and organic solvent. The organic solvent is preferably exemplified by alcohols, alkanols, monoethers of glycol compounds, ketones, amides, sulfoxides, ethers, or the like, more preferably exemplified by alcohols having a molecular weight of 61 or more, and even more preferably exemplified by glycols having a molecular weight of 61 or more. Specific examples thereof is ethylene glycol, propylene glycol, butane diol, pentane diol, hexane diol, glycerinmonomethylether, glycerinmonoethylether, cyclohexane diol, cyclohexanedimethanol, diethylene glycol, dipropylene glycol, or the like. The combined organic solvent with water may be used alone, or in combination of two or more kinds.

At least one organic solvent for the case where an organic solvent may be used alone or in combination of two or more kinds preferably has a high solubility with water. The solubility of the organic solvent in water is preferably 50% by mass or more, and it is more preferable that the organic solvent is freely mixed with water. It is possible to prepare an alkaline solution having a sufficient solubility for the alkaline agents, fatty acid salts additionally generated by the saponification, carbonates formed by absorbing carbon dioxide in the air, or the like.

The use ratio of the organic solvent in the solvent for alkaline solution is determined in accordance with the kind of solvent, a miscibility (solubility) with water, a reaction temperature and reaction time. In order to complete the saponification reaction for a short time, it is preferable to prepare a solution with a high concentration. However, when the concentration of the solvent is too high, components (plasticizer, etc.) of the acylate film may be extracted, or the film may be excessively swollen, thus it is required to appropriately select the concentration of solvent.

The water/organic solvent ratio is preferably in the range of 3/97 to 85/15, more preferably in the range of 5/95 to 60/40, and even more preferably in the range of 15/85 to 40/60, in a mass ratio. In this range, the whole surface of the acylate film is uniformly saponified without deteriorating the optical characteristics of the acylate film.

As the alkaline solution preferably used in the invention, an alkaline solution with a high concentration absorbs CO₂ in an environmental atmosphere that becomes a carbonic acid in the solution, thus pH of the solution is to be lowered and carbonate deposits is easily generated. Accordingly, the concentration of CO₂ in an environmental atmosphere is preferably 5000 ppm or less. In order to suppress the absorption of CO₂ in an environmental atmosphere, a coater for applying the alkaline solution more preferably has a semi-enclosed structure, or more preferably covered with a dried air, an inert gas or a saturated vapor of the organic solvent of the alkaline solution.

### (Surface Active Agent)

The alkaline solution used in the invention may contain a surface active agent. By adding the surface active agent, a film containing material stably exists in the alkaline solution even when the organic solvent allows the film containing material to be extracted. Accordingly, the extracted material is not deposited and solidified in a subsequent water washing process. The surface active agent which is preferably used is described in, for example, JP-A-2003-313326.

### (Antifoam Agent)

The alkaline solution used in the invention may contain an antifoam agent, and a preferred example of the antifoam agent is described in JP-A-2003-313326.

### (Fungusproof Agent/Antimicrobial Agent)

The alkaline solution used in the invention may contain a fungusproof agent and/or an antimicrobial agent, and a preferred example of the fungusproof agent/antimicrobial agent is described in JP-A-2003-313326.

### (Water)

It is preferable to use water for the alkaline solution on the basis of an effect on elements and minerals incorporated in the water prescribed by Japan Waterworks Law (Law No. 177 of 1957), an ordinance relating to the water quality standards under Japan Waterworks Law (Ordinance No. 56 of the Ministry of Health and Welfare, on Aug. 31, 1978), Japan Hot Spring Law (Law No. 125 and the attached list thereof on Jul. 10, 1948), and specified WHO water standards.

The above-mentioned water is preferably used to more reliably achieve the effects of the invention. The calcium concentration of the alkaline solution is preferably in the range of 0.001 to 400 mg/L, more preferably in the range of 0.001 to 150 mg/L, and even more preferably in the range of 0.001 to 10 mg/L, and the magnesium concentration of the alkaline solution is preferably in the range of 0.001 to 400 mg/L, more preferably in the range of 0.001 to 150 mg/L, and even more preferably in the range of 0.001 to 10 mg/L. It is also preferable that other polyvalent metal ions except for calcium and magnesium are not contained in the alkaline solution. The polyvalent metal ion concentration is preferably in the range of 0.002 to 1000 mg/L. In addition, it is also preferable that anions such as a chloride ion and a carbonate ion are not contained in the alkaline solution. The chloride ion concentration is preferably in the range of 0.001 to 500 mg/L, more preferably in the range of 0.001 to 300 mg/L, and even more preferably in the range of 0.001 to 100 mg/L. It is preferable that a carbonate ion is not contained in the alkaline solution. The carbonate ion concentration is preferably in the range of 0.001 to 3500 mg/L, more preferably in the range of 0.001 to 1000 mg/L, even more preferably in the range of 0.001 to 200 mg/L. In these concentration ranges, the generation of insoluble materials in the solution is suppressed.

### [Alkali Saponification]

The film according to the invention can be saponified with alkali, by a process of saponifying a film with the alkaline solution and a process of washing the alkaline solution from the film. A process of neutralizing the alkaline solution and a process of washing a neutralizing solution from the film may be included thereafter. These processes are preferably carried out while the film is conveyed, and a method of dipping a film in an alkaline solution as described in JP-A-2001-188130 or a method of applying an alkaline solution as described in JP-A-2004-203965 may be used.

Time for saponification is preferably from 1 minute to 10 minutes, more preferably from 2 to 8 minutes, and even more preferably from 3 to 6 minutes. When the saponification time is too long, the durability of a polarizing plate to be described later is deteriorated.

In a saponification process in which a film is dipped in an alkaline solution, it is preferable to convect a saponifying solution in a vessel of the saponifying solution. A float with a string, which has a gravity equal to that of the solution, is put in the solution, and the convection speed is measured by the amount of the unreeled string per unit time. The linear speed is preferably 1 m/min or more, more preferably in the range of 10 to 1000 m/min, even more preferably in the range of 30 to 500 m/min, and most preferably in the range of 50 to 300 m/min. The convection of the saponifying solution can be performed by a stirring blade in the solution vessel.

A difference between a temperature of the saponifying solution at the start of the saponification for the cellulose acylate film and a temperature of the saponifying solution at the end of the saponification for the cellulose acylate film is preferably 0.1° C. or more, more preferably in the range of 0.5 to 20° C., and even more preferably in the range of 3 to 10° C. In order to realize these temperature differences, a difference between a temperature of the saponifying solution in the vicinity of an inlet through which the film is dipped and a temperature of the saponifying solution in the vicinity of an outlet through which the film is taken out from the saponifying solution is set to be preferably 0.1° C. or more, more preferably in the range of 0.5 to 20° C., and even more preferably in the range of 3 to 10° C. Specifically, the difference can be set by using a method of providing a division plate in the vessel of alkaline solution to prevent the solution from flowing and of additionally providing a heater to increase a temperature. At this time, it is preferable that the temperature at the end of the saponification (the temperature in the vicinity of the outlet) is higher than the temperature at the start of the saponification. In this manner, the additives of the film can be prevented from being deposited, and the contact angle on the film can be efficiently reduced.

The additives of cellulose acylate film dissolved in the solution may adhere to the cellulose acylate film and cause bright spots (foreign matter defects) to be generated. Accordingly, activated carbons are preferably used to adsorb and remove the eluted components. The activated carbons have a function to remove coloring components in the saponifying solution, and the form and material thereof are not particularly limited. Specifically, it is preferable to employ a method of directly introducing the activated carbons into the vessel of the alkali saponifying solution or a method of circulating the saponifying solution between the vessel of the saponifying solution and an activated carbon-filled purifying device.

### [Retardation]

Humidity-dependences (ΔRe, ΔRth) of the retardation in an in-plane direction (Re) and the retardation in a film thickness direction (Rth) of the cellulose acylate film according to the invention is preferably 30 nm or less, more preferably 20 nm or less, even more preferably 15 nm or less, and most preferably 10 nm or less.

Three points (center, and end portions (positioned from both ends at 5% of the entire width)) in a width direction are sampled for three times in a longitudinal direction per 10 m, nine samples having a size of 3 cm×3 cm are taken, and then the retardation in the specification is obtained from an average value of the points obtained in accordance with the following method.

After a sample film is air conditioned at a temperature of 25° C. and a relative humidity of 60% for 24 hours, a retardation at a wavelength of 590 nm in a direction perpendicular to the film surface and in a direction inclined by per 10° in the range of +50° to −50° from a normal line of the film surface around a lagging phase axis as a rotation axis is measured by the use of an automatic double refraction meter (KOBRA-21ADH: made by Oji Scientific Instruments) at a temperature of 25° C. and a relative humidity of 60%. Accordingly, the retardation in an in-plane direction (Re) and the retardation in a film thickness direction (Rth) are calculated.

In order to grasp a fluctuation in retardation with a variation in humidity, the humidity-dependence of Re (ΔRe=Re(10%)−Re(80%)) and the humidity-dependence of Rth (ΔRth=Rth(10%)−Rth(80%)) are calculated from Re and Rth (Re(10%) and Rth(10%), respectively) calculated by air conditioning the film at a temperature of 25° C. and a relative humidity of 10% and measuring the retardation thereof, and Re and Rth (Re(80%) and Rth(80%), respectively) calculated by air conditioning the film at a temperature of 25° C. and a relative humidity of 80% and measuring the retardation thereof.

### [Polarizing Plate]

A polarizing plate is formed of a polarizer and two polarizing plates protecting films which protect both sides thereof. Since the cellulose acylate film according to the invention can be used as a protecting film for at least one side of the polarizing plate, the above-mentioned saponified cellulose acylate film can be preferably used. For example, as described in JP-A-2001-141926, a polarizer is produced by performing a stretching process in a longitudinal direction, between two pairs of nip rolls having a different peripheral speed, and then bonded to the cellulose acylate film, by means of an aqueous solution of polyvinyl alcohol or polyvinyl acetal (for example, polyvinyl butyral) or a latex of vinyl polymer (for example, polybutyl acrylate) as an adhesive, thus a polarizing plate can be prepared. At this time, a surface of the cellulose acylate film, having a contact angle of water less than 55°, is preferably used as an adhesion side, and a surface having a contact angle of water lower than the above-mentioned angle is more preferably used as a adhesion side.

When producing the polarizing plate according to the invention, any surface treatment other than the alkali saponification treatment may be concurrently carried out. For example, the surface treatments described in JP-A-6-94915, and JP-A-6-118232 may be carried out.

The polarizing plate prepared in this manner preferably has a low reduction in the polarization degree thereof after being left at a temperature of 60° C. and a relative humidity of 90% for 1000 hours. Reduction in polarization degree of a polarizing plate after being thermally treated at a temperature of 60° C. and a relative humidity of 90% for 1000 hours is preferably 0.1% or less, and more preferably 0.08% or less.

### [Use]

The film according to the invention is preferably used as the polarizing plate, and these film and polarizing plate are preferably used for the following liquid crystal display device.

### (Common Configuration of Liquid Crystal Display Device)

When a cellulose acylate film is used as an optical compensatory film, a polarizing element and an optical compensatory film having a cellulose acylate film are preferably so disposed that the transmission axis of the former and the lagging phase axis of the latter may form any angle. A liquid-crystal display device comprises a liquid-crystal cell that carries liquid crystal between two electrode substrates, two polarizing elements each disposed on both sides of the liquid-crystal cell, and at least one optical compensatory film disposed between the liquid-crystal cell and the polarizing element.

The liquid crystal layer of the liquid crystal cell is generally formed by filling the liquid crystal to a space which is formed between two substrates with a spacer interposed therebetween. Transparent electrode layers as transparent films including conductive materials are formed on the substrate. On the liquid crystal cell, a gas barrier layer, a hard coat layer, or an undercoat layer (used in bonding of the transparent electrode layers) may be provided. These layers are generally provided on the substrates. Generally, the substrate of the liquid crystal cell has a thickness in the range of 50 μm to 2 mm.

### (Type of Liquid Crystal Display Device)

The cellulose acylate film according to the invention, and a retardation plate, the optical compensatory sheet and the polarizing plate using the cellulose acylate film can be used for various display modes of liquid crystal display devices. The display mode includes TN (Twisted Nematic), IPS (In-Plane Switching), FLC (Ferroelectric Liquid Crystal), AFLC (Anti-ferroelectric Liquid Crystal), OCB (Optically Compensatory Bend), STN (Super Twisted Nematic), VA (Vertically Aligned), ECB (Electrically Controlled Birefringence), and HAN (Hybrid Aligned Nematic), ASM (Axially Symmetric Aligned Microcell). In addition, the display mode includes modes in which the alignment is divided in the above-mentioned display modes. A liquid crystal display device may be any one of transmission-type, reflection-type and transreflection-type liquid crystal display devices.

### (TN-Type Liquid Crystal Display Device)

The cellulose acylate film according to the invention may be used as a support of an optical compensatory sheet of a TN-type liquid crystal display device having a TN-mode liquid crystal cell. The TN-mode liquid crystal cell and the TN-type liquid crystal display device are well known since early times. The optical compensatory sheet used for the TN-type liquid crystal display device is described in JP-A-3-9325, JP-A-6-148429, JP-A-8-50206, and JP-A-9-26572. In addition, it is also described in a paper by Mori et al. (Jpn. J. Appl. Phys. Vol. 36 (1997) p. 143 and Jpn. J. Appl. Phys. Vol. 36 (1997) p. 1068).

### (STN-Type Liquid Crystal Display Device)

The cellulose acylate film according to the invention may be used as a support of an optical compensatory sheet of a STN-type liquid crystal display device having a STN-mode liquid crystal cell. In general, in the STN-type liquid crystal display device, rod-shaped liquid-crystalline molecules in the liquid crystal cell are aligned at an angle in the range of 90 to 360°, and the product (And) of refractive index anisotropy (Δn) of the rod-shaped liquid-crystalline molecules and cell gap (d) is in the range of 300 to 1500 nm. The optical compensatory sheet used for the STN-type liquid crystal display device is described in JP-A-2000-105316.

### (VA-Type Liquid Crystal Display Device)

The cellulose acylate film according to the invention is advantageously used as a support of an optical compensatory sheet of a VA-type liquid crystal display device having a VA-mode liquid crystal cell. The retardation Re and Rth of the optical compensatory sheet used for the VA-type liquid crystal display device are preferably set in the range of 0 to 150 nm and in the range of 70 to 400 nm, respectively. The retardation Re is more preferably in the range of 20 to 70 nm. When two optical anisotropic polymer films are used for the VA-type liquid crystal display device, the retardation Rth of the films is preferably in the range of 70 to 250 nm. When one optical anisotropic polymer film is used for the VA-type liquid crystal display device, the retardation Rth of the film is preferably in the range of 150 to 400 nm. The VA-type liquid crystal display device may be a liquid crystal display device in which alignment is divided as described in JP-A-10-123576.

### (IPS-Type Liquid Crystal Display Device and ECB-Type Liquid Crystal Display Device)

The cellulose acylate film according to the invention is also advantageously used as protecting films for polarizing plates or supports of optical compensatory sheets of a IPS-type liquid crystal display device having a IPS-mode liquid crystal cell and a ECB-type liquid crystal display device having a ECB-mode liquid crystal cell. In the modes, liquid crystal materials are aligned substantially horizontal at the time of a black level of display, and liquid crystal molecules are aligned parallel to a substrate surface with no application of a voltage for a black level of display. In this aspect, the polarizing plate using the cellulose acylate film according to the invention contributes to improvement in color display, wide visual field angle, and improvement in contrast. In this aspect, it is preferable that the polarizing plate using the cellulose acylate film according to the invention as the protecting films (cell-side protecting film) disposed between the liquid crystal cell and the polarizing plate among the protecting films for the upper and lower polarizing plates of the liquid crystal cell is disposed on at least one side of the liquid crystal cell. It is more preferable that the retardation of an optical anisotropic layer disposed between the protecting film for the polarizing plate and the liquid crystal cell is set to be not more than two times the value of Δn·d of the liquid crystal layer.

### (OCB-Type Liquid Crystal Display Device and HAN-Type Liquid Crystal Display Device)

The cellulose acylate film according to the invention is also advantageously used as supports of optical compensatory sheets of an OCB-type liquid crystal display device having an OCB-mode liquid crystal cell and a HAN-type liquid crystal display device having a HAN-mode liquid crystal cell. In the optical compensatory sheet used for the OCB-type liquid crystal display device or the HAN-type liquid crystal display device, the direction in which the absolute value of the retardation is the minimum does not exist in the normal line direction and in-plane direction of the optical compensatory sheet. The optical properties of the optical compensatory sheet used for the OCB-type liquid crystal display device or the HAN-type liquid crystal display device are also determined on the basis of the optical properties of the optical anisotropic layer, the optical properties of the support, and arrangement of the optical anisotropic layer and the support. The optical compensatory sheet used for the OCB-type liquid crystal display device or the HAN-type liquid crystal display device is described in JP-A-9-197397. In addition, it is also described in a paper by Mori et al. (Jpn. J. Appl. Phys. Vol. 38 (1999) p. 2837).

### (Reflection-Type Liquid Crystal Display Device)

The cellulose acylate film according to the invention is also advantageously used as optical compensatory sheets of TN-type, STN-type, HAN-type, and GH (Guest-Host)-type reflection-type liquid crystal display devices. The display modes are well known since early times. The TN-type reflection-type liquid crystal display device is described in JP-A-10-123478, Pamphlet of International Publication WO 98/48320, and Japanese Examined Patent Application Publication No. 3022477. The optical compensatory sheet used for the reflection-type liquid crystal display device is described in Pamphlet of International Publication WO 00/65384.

### (Other Liquid Crystal Display Devices)

The cellulose acylate film according to the invention is also advantageously used as a support of an optical compensatory sheet of an ASM-type liquid crystal display device having an ASM (Axially Symmetric Aligned Microcell)-mode liquid crystal cell. The ASM-mode liquid crystal cell is characterized in that the cell thickness thereof is held by a position-adjustable resin spacer. Its other characteristics thereof are the same as those of the TN-mode liquid crystal cell. The ASM-mode liquid crystal cell and the ASM-type liquid crystal display device is described in a paper by Kume et al. (Kume et al., SID 98 Digest 1089 (1998)).

### (Hard Coat Film, Antiglare Film, and Antireflection Film)

A hard coat film, an antiglare film, and an antireflection film may be preferably applied to the cellulose acylate film according to the invention. In order to improve the visibility of a flat-pannel display such as LCD, PDP, CRT, EL, etc., any one or all of the hard coat film, the antiglare film, and the antireflection film can be applied to one or both sides of the cellulose acylate film according to the invention. Preferable embodiments of the antiglare film and the antireflection film are described in detail in Hatsumei Kyokai Disclosure Bulletin (No. 2001-1745, published by Hatsumei Kyokai, on Mar. 15, 2001) pages 54 to 57, and the cellulose acylate film according to the invention can be preferably used.

### EXAMPLES

Hereinafter, the features of the invention will now be described more specifically based on examples. The materials, amounts thereof, proportions thereof, details of treatment, procedures thereof, etc. as will be set forth in the following description of examples may be modified or altered as desired without departing from the scope and spirit of the invention. Therefore, the scope of the invention is not to be limited by any of the specific examples which will now be given.

### <Measuring Method>

In this example, a contact angle of water, retardation, and variation in polarization degree were measured by the above-described method. Other measuring methods are as follows.

### (1) Substitution Degree of Cellulose Acylate

An acyl substitution degree of cellulose acylate was obtained by ¹³C-NMR spectroscopy, described in Carbohydr. Res. 273 (1995) 83-91 (TEZUKA et al.).

### (2) Polymerization Degree of Cellulose Acylate

About 0.2 g of an absolutely-dried polymer was precisely weighed, and then dissolved in 100 mL of a mixed solvent of dichloromethane and ethanol in a proportion of 9:1 (ratio by mass). Time in seconds required for the falling at a temperature of 25° C. was measured using an Ostwald viscometer, and polymerization degree DP was obtained by the following Formulae.

ηrel=T/T0 T: Time in seconds required for the falling of measurement sample

[η]=ln(ηrel)/C T: Time in seconds required for the falling of solvent without mixed solvent

DP=[η]/Km C: Concentration (g/L)
Km: 6×10⁻⁴

### (3) Tg

A 20 mg sample was placed on the measuring pan of a DSC. The temperature of this sample was raised from 30° C. to 250° C. at 10° C./min in a nitrogen atmosphere, and then cooled to 30° C. at −10° C./min. The temperature was then again raised from 30° C. to 250° C. Tg was taken as the temperature at which the base line began to inflect from the low temperature side.

### <Preparation and Evaluation of Cellulose Acylate Film>

### [Cellulose Acylate]

### (For Films 101 to 116)

200 parts by weight of cellulose (hardwood pulp) sprayed with 200 parts by weight of acetic acid was added to a reaction vessel equipped with a reflux equipment, and the mixture was stirred for 1 hour while heating it in an oil bath controlled at 40° C. The cellulose subjected to the pre-treatment as above was swollen and dissolved to have a fluffy shape. Then, the content was cooled to a room temperature or less.

Separately, an acetic acid, an acetic acid anhydride, and a propionic anhydride were added to prepare an acylating agent having a composition described in Table 1, 14 parts by weight of sulfuric acid as a catalyst was further added to the mixture, and the mixture was cooled to −25° C. After that, the mixture was added at once to the reaction vessel in which the cellulose subjected to the pre-treatment was placed. After 1.5 hours, interior temperature was increased to 22° C., and the mixture was reacted for 5.5 hours. The reaction vessel was cooled to −20° C., and a mixture of 366 parts by weight of water and 1099 parts by weight of acetic acid cooled to about 5° C. was added to the vessel for 1 hour. The interior temperature was increased to 80° C., and the mixture was stirred and ripened. By varying the ripening time, the cellulose acylate having a polymerization degree described in Table 1 was obtained.

Next, a mixed solution of 61 parts by weight of magnesium acetate tetrahydrate, 61 parts by weight of acetic acid, and 61 parts by weight of water was added (neutralization) to the reaction vessel, and stirred at 60° C. for 2 hours. While a proportion of water was gradually increased in a mixture of acetic acid and water, the mixed solution of acetic acid and water in a proportion of 1:1 was added to precipitate cellulose acetate propionate. The obtained precipitate of cellulose acetate propionate was sufficiently washed with warm water of 75° C. After washing, the precipitate of cellulose acetate propionate was stirred in 0.005% by mass of calcium hydroxide aqueous solution for 0.5 hours. Subsequently, the precipitate of cellulose acetate propionate was washed again with water till the pH of a washing solution became 7 and vacuum dried at 90° C., thereby obtaining cellulose acylate.

### (For Films 151 to 153)

CAP482-20 (acetyl substitution degree 0.18, propionyl substitution degree 2.49, polymerization degree 240), produced by Eastman Chemical Japan Limited., was purchased and used. The purchased cellulose acylate was heated and dried at 120° C. to have a water content of 0.5% by mass or less, and then 30 parts by mass thereof was used.

### (For Film 154)

CAB171-15 (acetyl substitution degree 2.02, butyl substitution degree 0.70, polymerization degree 220), produced by Eastman Chemical Japan Limited., was purchased and used. The purchased cellulose acylate was heated and dried at 120° C. to have a water content of 0.5% by mass or less, and then 30 parts by mass thereof was used.

### (For Films 155 to 166)

CAB381-20 (acetyl substitution degree 1.00, butyl substitution degree 1.66, polymerization degree 220), produced by Eastman Chemical Japan Limited., was purchased and used. The purchased cellulose acylate was heated and dried at 120° C. to have a water content of 0.5% by mass or less, and then 30 parts by mass thereof was used.

### [Solvent]

In preparing a cellulose acylate film, a mixed solvent of dichloromethane/methanol/butanol (68/13/3 parts by mass) was used. The water content of each used solvent was 0.2% by mass or less.

### [Additive]

The following additives A to H were selectively used as described in Table 1.

### (Additive A)

Retardation increasing agent A having the following structure: 0.9 parts by mass

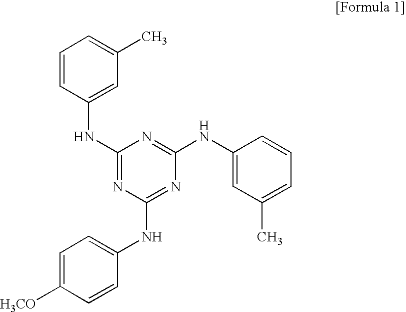

Silicon dioxide particle (particle size 20 nm, Mohs hardness about 7): 0.08 parts by mass

### (Additive B)

Triphenylphosphate: 0.8 parts by mass

Biphenyldiphenylphosphate: 0.4 parts by mass

Retardation increasing agent A: 0.9 parts by mass

Silicon dioxide particle (particle size 20 nm, Mohs hardness about 7): 0.08 parts by mass

### (Additive C)

Triphenylphosphate: 0.8 parts by mass

Biphenyldiphenylphosphate: 0.4 parts by mass

Sumisorb 130 (produced by Sumitomo Chemical Co., Ltd): 0.6 parts by mass

Silicon dioxide particle (particle size 20 nm, Mohs hardness about 7): 0.08 parts by mass

### (Additive D)

Retardation increasing agent B having the following structure: 0.9 parts by mass

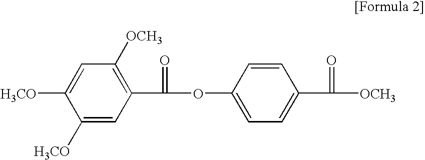

Silicon dioxide particle (particle size 20 nm, Mohs hardness about 7): 0.08 parts by mass

### (Additive E)

Retardation increasing agent C having the following structure: 0.9 parts by mass

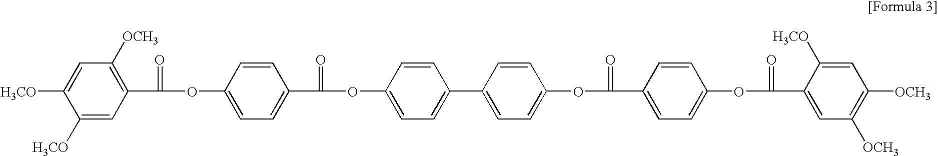

Silicon dioxide particle (particle size 20 nm, Mohs hardness about 7): 0.08 parts by mass

### (Additive F)

Polyethylene glycol (molecular weight 600): 1.2 parts by mass

Sumilizer GP (produced by Sumitomo Chemical Co., Ltd): 0.09 parts by mass

ADEKASU type LA-31 (produced by ASAHI DENKA KOGYO KABUSHIKI KAISHA): 0.33 parts by mass

Silicon dioxide particle (particle size 20 nm, Mohs hardness about 7): 0.08 parts by mass

### (Additive G)

Glycerin diacetatetolate: 1.2 parts by mass

Sumilizer GP (produced by Sumitomo Chemical Co., Ltd): 0.09 parts by mass

ADEKASU type LA-31 (produced by ASAHI DENKA KOGYO KABUSHIKI KAISHA): 0.33 parts by mass

Silicon dioxide particle (particle size 20 nm, Mohs hardness about 7): 0.08 parts by mass

### (Additive H)

Sumisorb 130 (produced by Sumitomo Chemical Co., Ltd): 0.6 parts by mass

Sumilizer GP (produced by Sumitomo Chemical Co., Ltd): 0.09 parts by mass

ADEKASU type LA-31 (produced by ASAHI DENKA KOGYO KABUSHIKI KAISHA): 0.33 parts by mass

Silicon dioxide particle (particle size 20 nm, Mohs hardness about 7): 0.08 parts by mass

### [Swelling, Dissolution]

To a stainless-steel dissolving tank of 400 L which has a stirring blade and in which a coolant circulates around a periphery thereof, the cellulose acylate was gradually added while the solvent and additive were added, stirred, and dispersed. After the addition, the mixture was stirred for 1-hour, swollen for 1 hour, and stirred again to obtain a cellulose acylate solution.

For the stirring, a dissolver type deflection-center-stirring shaft which is stirred at a peripheral speed of 15 m/sec (shearing stress 5×10⁴ kgf/m/sec²), and a stirring shaft which has an anchor blade in the center shaft thereof and is stirred at a peripheral speed of 1 m/sec (shearing stress 1×10⁴ kgf/m/sec²) were used. The swelling was carried out by stopping the high-speed stirring shaft and adjusting the peripheral speed of the stirring shaft having an anchor blade to be 0.5 m/sec.

### [Filtration]

The obtained cellulose acylate solution was filtered with a filter paper having an absolute filtration accuracy of 0.01 mm (#63, produced by Toyo Roshi Kaisha Ltd.), and further filtered with a filter paper having an absolute filtration accuracy of 2.5 μm (FH025, produced by Pall Corporation), thereby obtaining a cellulose acylate solution.

### [Solution-Casting Film Formation]

### (Film Formation of Films 101 to 111 and 151 to 166)

The cellulose acylate film was heated at 25° C., was passed through a casting-giesser (described in JP-A-11-314233) set at 20° C., and then was cast on a mirror-surface stainless-steel support set at 15° C. and having a band length of 60 m. The casting speed was set to be 15 m/min, and the application width was set to be 200 cm. The space temperature of the whole casting section was set to a temperature of 15° C. The polymer film having been cast and rotated was peeled off from the band at a position ahead of the last stop of the casting section by 50 cm, was dried at 100° C. for 10 minutes, and was further dried 105° C. for 20 minutes. Then, the film was cooled at a room temperature for 10 seconds, thereby obtaining a cellulose acylate film having a thickness of 100 μm. The obtained film was cut at both ends thereof to have a width of 3 cm, and additionally, a knurling having a height of 125 μm was applied to a position apart from the end by 2 to 10 mm to wind the film to be a roll of 1000 m.

### [Melt-Casting Film Formation]

### (Film Formation of Films 112 to 114)

1) Pelletization

In examples, the cellulose acylate and the additive described in Table 1 were added to a double-screw kneading extruder equipped with a vacuum-degasifier, and the mixture was extruded out from a die at a screw revolution speed of 300 rpm, for screw time of 40 seconds, and at an extrusion rate of 200 kg/hr. Then, the extruded mixture was solidified in water at 60° C. and cut, thereby obtaining a cylindrical pellet having a diameter of 2 mm and a length of 3 mm.

2) Filtration, Melt Extrusion

The pellet prepared by the above-described method was dried at 100° C. for 5 hours with a dehumidifying airstream with −40° C. dew-point temperature, so that the moisture content thereof is no more than 0.01% by mass. The dried pellet was charged into an 80° C. hopper. A melt-extruder was adjusted to have the inlet temperature (T1) of 190° C., the outlet temperature (T2) of 210° C., and the die temperature (T3) of 220° C. The diameter of the screw (outlet side) employed at this stage was 60 mm, L/D was 50, and the compression ratio was 4. The inlet side of the screw was cooled by circulating an oil at (Tg of the pellet—5° C.) in the interior of the screw. The residence time of resin in the barrel was 5 minutes. The temperature of the inside the barrel was set so as to adjust the temperatures of the barrel inlet and the barrel outlet to the lowest temperature and the highest temperature respectively. The resin extruded from the extruder was conveyed at a fixed quantitative amount using a gear pump, although at this stage the extruder revolution speed varied in order to control the resin pressure upstream of the gear pump at a fixed pressure of 10 MPa. The molten resin conveyed from the gear pump was filtered using a 5 μm filtration accuracy leaf disc filter, passed through a static mixer, extruded from a coat hanger die having 0.8 mm slit intervals, and then solidified with a casting drum at (Tg-10° C.). In this step, an electrostatic application method (a wire at 10 kV was disposed on a position apart from the landing point of the melt on the casting drum by 10 cm) was used to perform electrostatic application at both ends by 10 cm. The solidified melt was peeled off from the casing drum, and immediately before taking up and cut at both ends thereof to have a width of 7.5 cm, and then, a knurling having a width of 10 mm and a height of 50 μm was applied both ends thereof to wind 3000 m of the cut film at 30 m/min. The width of the film was 1.5 m.

### (Film Formation of Film 115)

A film was formed in the same manner as the above-mentioned processes of “Pelletization” and “Filtration, Melt Extrusion”, except that a touch roll (described as a double restraining roll, where the thickness of a thin metal outer jacket was set to be 3 mm) described in Example 1 of JP-A-11-235747 was used to carry out touch roll film formation. Minute unevenness of the film and blur on LCD were improved by the touch roll film formation.

### (Film Formation of Film 116)

A film was formed in the same manner as the above-mentioned processes of “Pelletization” and “Filtration, Melt Extrusion” for forming the films 112 to 114, except that a touch roll (described as a sheet molding roll, where a coolant used in a metal outer jacket was changed from an oil at 18° C. to an oil at 120° C.) described in Pamphlet of International Publication WO 97/28950 was used to carry out the touch roll film formation. Minute unevenness of the film and blur on LCD were improved by the touch roll film formation.

### [Stretching]

### (Stretching of Films 101 to 116, 151 to 155, and 157 to 166)

The films formed as described above were stretched by 30%, at a temperature of (Tg of each cellulose acylate film+10° C.) and 20%/sec in a TD direction.

### [Preparation of Films 191 to 194]

Separately from the above preparing processes, FUJITAC (TD80UL), produced by FUJI PHOTO FILM CO., LTD., was purchased as a cellulose acylate film and used as films 191 to 194 as follows.

### [Saponification]

The following conditions 11 to 15, and 21 to 22 were selected to carry out saponification as described in Table 1.

### (Condition 11: Dipping Treatment)

400 parts by mass of sodium hydroxide was dissolved in 3000 parts by mass of water to prepare an alkaline aqueous solution, and the alkaline aqueous solution was delivered to a vessel of alkaline solution. The convection speed and the temperature of the saponifying solution was adjusted to be 50 m/min and 54° C., respectively, and a division plate was provided to adjust the temperature of the solution in the vicinity of the outlet of the film to be 58° C. The film was dipped for 2 minutes, and then was washed with water. After that, the film was dipped in a sulfuric acid aqueous solution of 0.05 mol/L for 30 seconds, and further passed through a water washing bath. Water draining performed by an air knife was repeated three times to remove water, and the film was placed and dried in a drying zone at 70° C. for 15 seconds, thereby producing a saponified film.

### (Condition 12: Dipping Treatment)

A saponified film was prepared in the same manner as the method of Condition 11, except that 400 parts by mass of sodium hydroxide was dissolved in 1500 parts by mass of water and 1500 parts by mass of propylene glycol was subsequently added thereto to prepare an alkaline aqueous solution.

### (Condition 13: Dipping Treatment)

A saponified film was prepared in the same manner as the method of Condition 11, except that the convention speed of the saponifying solution was adjusted to be 0.5 m/min.

### (Condition 14: Dipping Treatment)

A saponified film was prepared in the same manner as the method of Condition 11, except that the temperature of the solution was adjusted to be 58° C. and the temperature of the solution in the vicinity of the outlet of the film was adjusted to be 50° C.

### (Condition 15: Dipping Treatment)

A saponified film was prepared in the same manner as the method of Condition 11, except that 120 parts by mass of sodium hydroxide was dissolved in 3000 parts by mass of water to prepare an alkaline aqueous solution.

(Condition 21: Applying Treatment)

400 parts by mass of sodium hydroxide was dissolved in 3000 parts by mass of water and then 100 parts by mass of the following nonionic detergent A and 2 parts by mass of antifoam agent SURFYNOL DF110D (produced by Nissin Chemical Industry Co., Ltd) were added thereto to prepare an alkaline aqueous solution. In addition, an alkaline dilution was prepared from 300 parts by mass of propylene glycol and 1 part by mass of antifoam agent SURFYNOL DF110D (produced by Nissin Chemical Industry Co., Ltd), and 9700 parts by mass of water.

C₁₄H₂₉O—(CH₂CH₂O)₁₀—H Nonionic detergent A

A cellulose acylate film passed through a dielectric heating roll heated to 60° C., and was heated to 30° C. Then, the above alkaline aqueous solution kept warm at 30° C. was applied at 15 mL/m² by a rod coater. Under a steam-type far-infrared heater heated at 110° C., which is manufactured by Noritake Co., Limited, the film was placed for 10 seconds (film temperature is in the range of 30 to 50° C.), and then the above alkaline dilution was applied at 20 mL/m² by the rod coater in the same manner as above to wash the alkali. In this step, the film temperature was maintained in the range of 40 to 55° C. Subsequently, water washing performed by a fountain coater and water draining performed by the air knife were repeated three times to wash the alkaline agent, and then the film was placed and dried in a drying zone at 70° C. for 15 seconds, thereby preparing a saponified film.

### (Condition 22)

The saponification was carried out in accordance with the conditions in Example 1 of JP-A-2004-203965.

560 parts by mass of potassium hydroxide was dissolved in 1578 parts by mass and then 6080 parts by mass of isopropanol, 1680 parts by mass of diethylene glycol, 100 parts by mass of nonionic detergent A and 2 parts by mass of antifoam agent SURFYNOL DF110D (produced by Nissin Chemical Industry Co., Ltd.) were added thereto to prepare an alkaline aqueous solution. In addition, an alkaline dilution was prepared by 500 parts by mass of isopropanol, 200 parts by mass of diethylene glycol, 1 part by mass of antifoam agent SURFYNOL DF110D (produced by Nissin Chemical Industry Co., Ltd), and 9299 parts by mass of pure water.

### [Evaluation of Film]

The saponifying solution was exchanged with a new saponifying solution, and the film was saponified by 10 km in accordance with the above-described saponification method. The film saponified by 10 km was sampled, and contact angles of water and variations in retardation with variations in humidity were obtained and described in Table 1. The contact angle of water described in Table 1 is a value of a surface having a lower contact angle.

TABLE 1

| | Cellulose Acytate | | | | | |
|---|---|---|---|---|---|---|
| | Acetyl | Propionyl | Butyl | | | |
| | Substi- | Substi- | Substi- | Polymeri- | | |
| | tution | tution | tution | zation | | |
| Film | Degree | Degree | Degree | Degree | Additive | Saponifying Condition |
| Film 101 (The invention) | 0.23 | 2.50 | 0.00 | 250 | Additive A | Condition 11 (The invention) |
| Film 102 (The invention) | 1.01 | 0.00 | 1.66 | 230 | Additive A | Condition 11 (The invention) |
| Film 103 (The invention) | 2.06 | 0.79 | 0.00 | 250 | Additive A | Condition 11 (The invention) |
| Film 104 (The invention) | 1.93 | 0.77 | 0.00 | 250 | Additive A | Condition 11 (The invention) |
| Film 105 (The invention) | 1.52 | 0.00 | 1.21 | 240 | Additive A | Condition 11 (The invention) |
| Film 106 (Comparative example) | 1.52 | 0.00 | 1.21 | 240 | Additive A | Condition 13 (The invention) |
| Film 107 (Comparative example) | 1.52 | 0.00 | 1.21 | 240 | Additive A | Condition 14 (The invention) |
| Film 108 (Comparative example) | 1.52 | 0.00 | 1.21 | 240 | Additive A | Condition 15 (Comparative example) |
| Film 109 (The invention) | 2.01 | 0.00 | 0.70 | 250 | Additive A | Condition 11 (The invention) |
| Film 110 (The invention) | 2.42 | 0.32 | 0.00 | 280 | Additive B | Condition 11 (Comparative example) |
| Film 111 (The invention) | 2.43 | 0.00 | 0.31 | 270 | Additive B | Condition 11 (Comparative example) |
| Film 112 (The invention) | 0.31 | 2.50 | 0.00 | 150 | Additive F | Condition 11 (The invention) |
| Film 113 (The invention) | 0.31 | 2.50 | 0.00 | 150 | Additive G | Condition 11 (The invention) |
| Film 114 (The invention) | 0.31 | 2.50 | 0.00 | 150 | Additive H | Condition 11 (The invention) |
| Film 115 (The invention) | 0.31 | 2.50 | 0.00 | 150 | Additive G | Condition 11 (The invention) |
| Film 116 (The invention) | 0.31 | 2.50 | 0.00 | 150 | Additive G | Condition 11 (The invention) |
| Film 151 (The invention) | 0.18 | 2.49 | 0.00 | 240 | Additive A | Condition 11 (The invention) |
| Film 152 (Comparative example) | 0.18 | 2.49 | 0.00 | 240 | Additive A | Condition 13 (The invention) |
| Film 153 (Comparative example) | 0.18 | 2.49 | 0.00 | 240 | Additive A | Condition 15 (Comparative example) |
| Film 154 (The invention) | 2.02 | 0.00 | 0.70 | 220 | Additive A | Condition 11 (The invention) |
| Film 155 (The invention) | 1.00 | 0.00 | 1.66 | 220 | Additive A | Condition 11 (The invention) |
| Film 156 (The invention) | 1.00 | 0.00 | 1.66 | 220 | Additive A | Condition 11 (The invention) |
| Film 157 (The invention) | 1.00 | 0.00 | 1.66 | 220 | Additive A | Condition 12 (The invention) |
| Film 158 (Comparative example) | 1.00 | 0.00 | 1.66 | 220 | Additive A | Condition 13 (The invention) |
| Film 159 (Comparative example) | 1.00 | 0.00 | 1.66 | 220 | Additive A | Condition 14 (The invention) |
| Film 160 (Comparative example) | 1.00 | 0.00 | 1.66 | 220 | Additive A | Condition 15 (Comparative example) |
| Film 161 (The invention) | 1.00 | 0.00 | 1.66 | 220 | Additive A | Condition 21 (The invention) |
| Film 162 (Comparative example) | 1.00 | 0.00 | 1.66 | 220 | Additive A | Condition 22 (Comparative example) |
| Film 163 (The invention) | 1.00 | 0.00 | 1.66 | 220 | Additive B | Condition 11 (The invention) |
| Film 164 (The invention) | 1.00 | 0.00 | 1.66 | 220 | Additive C | Condition 11 (The invention) |
| Film 165 (The invention) | 1.00 | 0.00 | 1.66 | 220 | Additive D | Condition 11 (The invention) |
| Film 166 (The invention) | 1.00 | 0.00 | 1.66 | 220 | Additive E | Condition 11 (The invention) |
| Film 191 (Comparative example) | — | 0.00 | 0.00 | — | — | Condition 11 (Comparative example) |
| Film 192 (Comparative example) | — | 0.00 | 0.00 | — | — | Condition 12 (Comparative example) |
| Film 193 (Comparative example) | — | 0.00 | 0.00 | — | — | Condition 15 (Comparative example) |
| Film 194 (Comparative example) | — | 0.00 | 0.00 | — | — | Condition 22 (Comparative example) |

| | |
|---|---|
| Contact Angle of Water | Retardation Variation with |

| | |
|---|---|
| After | Temperature Variation |

| | Unsaponi- | Saponi- | ΔRe | ΔRth |
|---|---|---|---|---|
| Film | fication | fication | (10%-80%) | (10%-80%) |
| Film 101 (The invention) | 71 | 25 | 7 | 12 |
| Film 102 (The invention) | 75 | 48 | 8 | 11 |
| Film 103 (The invention) | 68 | 22 | 20 | 29 |
| Film 104 (The invention) | 69 | 21 | 21 | 30 |
| Film 105 (The invention) | 73 | 45 | 12 | 19 |
| Film 106 (Comparative example) | 73 | 59 | 11 | 19 |
| Film 107 (Comparative example) | 73 | 57 | 12 | 20 |
| Film 108 (Comparative example) | 73 | 68 | 11 | 18 |
| Film 109 (The invention) | 71 | 39 | 18 | 28 |
| Film 110 (The invention) | 67 | 37 | 23 | 34 |
| Film 111 (The invention) | 72 | 43 | 21 | 31 |
| Film 112 (The invention) | 64 | 25 | 8 | 17 |
| Film 113 (The invention) | 66 | 26 | 8 | 14 |
| Film 114 (The invention) | 65 | 26 | 8 | 16 |
| Film 115 (The invention) | 66 | 26 | 7 | 12 |
| Film 116 (The invention) | 66 | 26 | 8 | 13 |
| Film 151 (The invention) | 70 | 24 | 7 | 12 |
| Film 152 (Comparative example) | 70 | 57 | 6 | 12 |
| Film 153 (Comparative example) | 70 | 61 | 6 | 11 |
| Film 154 (The invention) | 72 | 39 | 18 | 29 |
| Film 155 (The invention) | 75 | 40 | 7 | 11 |
| Film 156 (The invention) | 75 | 46 | 2 | 9 |
| Film 157 (The invention) | 75 | 29 | 8 | 10 |
| Film 158 (Comparative example) | 75 | 62 | 7 | 11 |
| Film 159 (Comparative example) | 75 | 58 | 7 | 11 |
| Film 160 (Comparative example) | 75 | 70 | 8 | 11 |
| Film 161 (The invention) | 75 | 41 | 7 | 10 |
| Film 162 (Comparative example) | 75 | Whiten(*1) | — | — |
| Film 163 (The invention) | 79 | 45 | 5 | 8 |
| Film 164 (The invention) | 67 | 34 | 7 | 10 |
| Film 165 (The invention) | 77 | 40 | 7 | 11 |
| Film 166 (The invention) | 72 | 38 | 8 | 12 |
| Film 191 (Comparative example) | 64 | 18 | 4 | 42 |
| Film 192 (Comparative example) | 64 | 33 | 4 | 41 |
| Film 193 (Comparative example) | 64 | 23 | 4 | 38 |
| Film 194 (Comparative example) | 64 | 20 | 3 | 36 |

### [Evaluation of Saponification Method]

The dipping method of Condition 15 using the alkaline solution with a low concentration is preferably used to saponify the known cellulose acylate film, but can not be effectively carried out for saponification in the above test. Moreover, the film was whitened and a surface smoothness was deteriorated in the application method of Condition 22 using the alkaline solution with a low concentration. However, the saponification was more effective when it was carried out in accordance with the saponification method of Conditions 11 to 14 and 21 satisfying the requirements of the invention, thereby form a more reduced contact angle of water.

In addition, it was verified that more preferable conditions exists among the conditions satisfying the requirements of the invention. That is, the cellulose acylate film in which a fluctuation in retardation with a variation in humidity is small was more effectively saponified when the method of convecting the saponifying solution as Conditions 11 and 12 was employed in comparison with the method of not convecting the saponifying solution as Condition 13. Further, the saponification was more effectively carried out when the temperature of the solution in the vicinity of the outlet was increased as Conditions 11 and 12 in comparison with the case where the temperature of the solution in the vicinity of the outlet was reduced as Condition 14. In addition, the saponification may be more effectively carried out when the organic solvent was contained in the saponifying solution (Condition 12).

### <Preparation and Evaluation of Polarizing Plate>

### [Construction of Polarizer]

As described in Example 1 of JP-A-2001-141926, a film was stretched in the machine direction, between two pairs of nip rolls having a different peripheral speed to prepare a polarizing film having a thickness of 20 μm.

### [Bonding]

### (Polarizing Plates 101 to 116, 151 to 161, 163 to 166, 191 to 194, 201, and 202)

Two saponified films (respectively, defined as Film A and Film B, and described in Table 2) were selected among the films saponified as above, and the saponified surfaces of the films were disposed on the polarizer, thus the obtained polarizing layer was interposed between the films. Then, the polarizing layer was bonded to the films using an aqueous 3% PVA (PVA-117H, produced by KURARAY CO., LTD.) as an adhesive, in such a manner that the polarization axis is perpendicular to the machine direction of the film. In Table 2, Panlite C1400 (produced by TEIJIN CHEMICALS LTD.) was used for the polycarbonate, and ARTON FILM (film thickness 80 μm, produced by JSR Corporation) was used for the COC.

### (Polarizing Plates 203 and 204)

Two saponified films (respectively, defined as Film A and Film B, and described in Table 2) were selected among the films saponified as above, and the unsaponified surfaces of the films were disposed on the polarizer, thus the obtained polarizing layer was interposed between the films. Then, the polarizing layer was bonded to the films using an aqueous 3% PVA (PVA-117H, produced by KURARAY CO., LTD.) as an adhesive, in such a manner that the polarization axis is perpendicular to the machine direction of the film.

### [Evaluation of Polarizing Plate]

### (Bonding Property)

Bonding property of the films to the polarizer was visually checked in accordance with the following references.

The results were described in Table 2.

∘: The film had an excellent bonding property, and was not peeled off from the polarizer after the following thermal treatment.

Δ: The film had an excellent bonding property. However, the end portion of the film was peeled off from the polarizer after the following thermal treatment.

x: The film was peeled off from the polarizer just after the film was bonded to the polarizer. Or, the film did not be bonded to the polarizer.

### (Polarization Degree Variation)

The film A side of the polarizing plate was bonded to a glass substrate with an adhesive, and thermally treated at a temperature of 60° C. and a relative humidity of 90% for 1000 hours. Then, bonding property between the film and the polarizer was visually checked. Polarization degree variation before and after the thermal treatment (polarization degree before the thermal treatment [%]−polarization degree after the thermal treatment [%]) was obtained and described in Table 2.

TABLE 2

| | | | Evaluation of Polarizing Plate | | |
|---|---|---|---|---|---|
| | | | | Reduction in | |
| | Protecting Film | | Bonding | Polarization | |
| Polarizing Plate | Film A | Film B | Property | Degree | Remarks Column |
| Polarizing Plate 101 | Film 101 | Film 193 | ◯ | −0.96 | The invention |
| Polarizing Plate 102 | Film 102 | Film 193 | ◯ | −1.07 | The invention |
| Polarizing Plate 103 | Film 103 | Film 193 | ◯ | −0.94 | The invention |
| Polarizing Plate 104 | Film 104 | Film 193 | ◯ | −0.93 | The invention |
| Polarizing Plate 105 | Film 105 | Film 193 | ◯ | −1.02 | The invention |
| Polarizing Plate 106 | Film 106 | Film 193 | Δ | −1.73 | Comparative example |
| Polarizing Plate 107 | Film 107 | Film 193 | Δ | −1.52 | Comparative example |
| Polarizing Plate 108 | Film 108 | Film 193 | X | — | Comparative example |
| Polarizing Plate 109 | Film 109 | Film 193 | ◯ | −0.99 | The invention |
| Polarizing Plate 110 | Film 110 | Film 193 | ◯ | −0.97 | The invention |
| Polarizing Plate 111 | Film 111 | Film 193 | ◯ | −0.95 | The invention |
| Polarizing Plate 112 | Film 112 | Film 193 | ◯ | −1.07 | The invention |
| Polarizing Plate 113 | Film 113 | Film 193 | ◯ | −0.96 | The invention |
| Polarizing Plate 114 | Film 114 | Film 193 | ◯ | −0.94 | The invention |
| Polarizing Plate 115 | Film 115 | Film 193 | ◯ | −0.93 | The invention |
| Polarizing Plate 116 | Film 116 | Film 193 | ◯ | −0.95 | The invention |
| Polarizing Plate 151 | Film 151 | Film 193 | ◯ | −0.94 | The invention |
| Polarizing Plate 152 | Film 152 | Film 193 | Δ | −1.51 | Comparative example |
| Polarizing Plate 153 | Film 153 | Film 193 | X | — | Comparative example |
| Polarizing Plate 154 | Film 154 | Film 193 | ◯ | −0.99 | The invention |
| Polarizing Plate 155 | Film 155 | Film 193 | ◯ | −1.04 | The invention |
| Polarizing Plate 156 | Film 156 | Film 193 | ◯ | −1.01 | The invention |
| Polarizing Plate 157 | Film 157 | Film 193 | ◯ | −1.09 | The invention |
| Polarizing Plate 158 | Film 158 | Film 193 | X | — | Comparative example |
| Polarizing Plate 159 | Film 159 | Film 193 | Δ | −1.75 | Comparative example |
| Polarizing Plate 160 | Film 160 | Film 193 | X | — | Comparative example |
| Polarizing Plate 161 | Film 161 | Film 193 | ◯ | −0.99 | The invention |
| Polarizing Plate 163 | Film 163 | Film 193 | ◯ | −1.12 | The invention |
| Polarizing Plate 164 | Film 164 | Film 193 | ◯ | −1.00 | The invention |
| Polarizing Plate 165 | Film 165 | Film 193 | ◯ | −1.02 | The invention |
| Polarizing Plate 166 | Film 166 | Film 193 | ◯ | −0.99 | The invention |
| Polarizing Plate 191 | Film 191 | Film 193 | ◯ | −1.58 | Comparative example |
| Polarizing Plate 192 | Film 192 | Film 193 | ◯ | −1.75 | Comparative example |
| Polarizing Plate 193 | Film 193 | Film 193 | ◯ | −0.94 | Comparative example |
| Polarizing Plate 194 | Film 194 | Film 193 | ◯ | −0.92 | Comparative example |
| Polarizing Plate 201 | Polycarbonate | Film 193 | X | — | Comparative example |
| Polarizing Plate 202 | COC | Film 193 | X | — | Comparative example |
| Polarizing Plate 203 | Film 161(*1) | Film 193 | X | — | Comparative example |
| Polarizing Plate 204 | Film 194(*1) | Film 193 | Δ | −1.92 | Comparative example |

The cellulose acylate film having a small contact angle of water according to the invention had an excellent bonding property to the polarizer. A film having a larger contact angle than that of the film according to the invention had a poor bonding property to the polarizer, or, even if the film having a higher contact angle was bonded to the polarizer, it was partially or entirely peeled off after the thermal treatment or its reduction in polarization degree was very large. In addition, when the known, generally used cellulose acetate was saponified in accordance with the preparation method of the invention, the contact angle was reduced but the reduction in polarization degree became large. Accordingly, it was understood that it is important to select saponifying conditions depending on films.

### <Construction of Liquid Crystal Display Device>

The cellulose acylate film and the polarizing plate according to the invention were mounted on a liquid crystal display device to determine whether the optical properties thereof are sufficient. Here, a VA-type liquid crystal cell was used, but the use of the cellulose acylate film and the polarizing plate according to the invention is not limited to operation modes of the liquid crystal display device.

[Mounting Evaluation onto VA-Type Liquid Crystal Display Device]

The polarizing plate was bonded to the VA-type liquid crystal display device described in FIGS. 2 to 9 of JP-A-2000-154261 with an adhesive so that the film A side of the polarizing plate became the liquid crystal cell side. The following evaluation was performed to the constructed liquid crystal display device, and the results were described in Table 3.

### (Color Change)

A panel left at a relative temperature of 10% for two weeks and a panel left a relative temperature of 80% for two weeks were arranged, and a difference between colors of the panels was visually checked and evaluated in accordance with the following references.

⊚: Color change due to a variation in humidity was not shown, and the panel displayed a high-quality image.

◯: Color change due to a variation in humidity was hardly shown, and the panel had sufficient characteristics to display an image not requiring a high-quality.

Δ: Color change due to a variation in humidity was shown a little, but the panel had sufficient characteristics to be used in a circumstance where a temperature and a humidity was controlled.

X: Color change due to a variation in humidity was sufficiently shown, and the panel showed a poor performance.

TABLE 3

| | | Color Change due to a | |
|---|---|---|---|
| Liquid Crystal Display Device | Polarizing Plate | Variation in Temperature | Remarks Column |
| Liquid Crystal Display Device 101 | Polarizing Plate 101 | ⊙ | The invention |
| Liquid Crystal Display Device 102 | Polarizing Plate 102 | ⊙ | The invention |
| Liquid Crystal Display Device 103 | Polarizing Plate 103 | ◯ | The invention |
| Liquid Crystal Display Device 104 | Polarizing Plate 104 | ◯ | The invention |
| Liquid Crystal Display Device 105 | Polarizing Plate 105 | ◯ | The invention |
| Liquid Crystal Display Device 109 | Polarizing Plate 109 | ◯ | The invention |
| Liquid Crystal Display Device 110 | Polarizing Plate 110 | Δ | The invention |
| Liquid Crystal Display Device 111 | Polarizing Plate 111 | Δ | The invention |
| Liquid Crystal Display Device 112 | Polarizing Plate 112 | ◯ | The invention |
| Liquid Crystal Display Device 113 | Polarizing Plate 113 | ⊙ | The invention |
| Liquid Crystal Display Device 114 | Polarizing Plate 114 | ◯ | The invention |
| Liquid Crystal Display Device 115 | Polarizing Plate 115 | ⊙ | The invention |
| Liquid Crystal Display Device 116 | Polarizing Plate 116 | ⊙ | The invention |
| Liquid Crystal Display Device 151 | Polarizing Plate 151 | ⊙ | The invention |
| Liquid Crystal Display Device 154 | Polarizing Plate 154 | ◯ | The invention |
| Liquid Crystal Display Device 155 | Polarizing Plate 155 | ⊙ | The invention |
| Liquid Crystal Display Device 157 | Polarizing Plate 157 | ⊙ | The invention |
| Liquid Crystal Display Device 161 | Polarizing Plate 161 | ⊙ | The invention |
| Liquid Crystal Display Device 163 | Polarizing Plate 163 | ⊙ | The invention |
| Liquid Crystal Display Device 164 | Polarizing Plate 164 | ⊙ | The invention |
| Liquid Crystal Display Device 165 | Polarizing Plate 165 | ⊙ | The invention |
| Liquid Crystal Display Device 166 | Polarizing Plate 166 | ⊙ | The invention |
| Liquid Crystal Display Device 191 | Polarizing Plate 191 | X | Comparative example |
| Liquid Crystal Display Device 192 | Polarizing Plate 192 | X | Comparative example |
| Liquid Crystal Display Device 193 | Polarizing Plate 193 | X | Comparative example |
| Liquid Crystal Display Device 194 | Polarizing Plate 194 | X | Comparative example |

Since the liquid crystal display device, using the film of the invention which has an excellent bonding property and in which a fluctuation in retardation with a variation in humidity is small, had small color change, its reliability was high.

### INDUSTRIAL APPLICABILITY

A cellulose acylate film according to the invention has a small contact angle of water, thus has a small fluctuation in retardation with a variation in humidity. Accordingly, when using the cellulose acylate film of the invention, the film can be bonded to a polarizer including polyvinyl alcohol as a main component in on-line, thus a polarizing plate and a liquid crystal display device, which have a high reliability, can be manufactured with high productivity. A cellulose acylate film having these excellent properties can be easily obtained in accordance with a saponification method according to the invention, thus the invention has a high industrial applicability.

1. A cellulose acylate film, wherein
at least one surface thereof has a contact angle of water of less than 55°,
all or a part of hydroxyl groups of the cellulose is substituted for an acetyl group, a propyonyl group and/or a butyryl group, and
the cellulose acylate satisfies Formulae (1b) and (2b):
1.5≦SP≦3.0 Formula (1b)
1.0≦SB≦3.0 Formula (2b)
where SP represents a substitution degree of hydroxyl groups of the cellulose for a Propionyl group, and SB represents a substitution degree of hydroxyl groups of the cellulose for a butyryl group.

2. (canceled)

3. The cellulose acylate film according to claim 1, wherein a difference between a retardation in an in-plane direction (Re) measured at a relative humidity of 10% and a retardation in the in-plane direction (Re) measured at a relative humidity of 80% is 30 nm or less, and a difference between a retardation in a film thickness direction (Rth) measured at a relative humidity of 10% and a retardation in the film thickness direction (Rth) measured at a relative humidity of 80% is 30 nm or less.

4-7. (canceled)

8. The cellulose acylate film according to 7 claim 1, which comprises a hydrophobic compound in an amount of 0 to 15% by mass with respect to the mass of polymers contained in the film.

9. A polarizing plate comprising at least one sheet of the cellulose acylate film according to claim 1.

10. The polarizing plate according to claim 9, wherein the surface having a contact angle of water of less than 55° is bonded to a polarizer.

11. The polarizing plate according to claim 9, wherein polarization degree is reduced by 0.1% or less after the polarizing plate is left at a temperature of 60° C. under a relative humidity of 90% for 1000 hours.

12. A liquid crystal display device comprising at least one sheet of the cellulose acylate film according to claim 1.

13. A method for saponification of cellulose acylate film which comprises saponifying a cellulose acylate film satisfying Formulae (1b) and/or (2b) using an alkaline solution having a concentration of 3 mol/L or more as a saponifying solution:
1.5≦SP≦3.0 Formula (1b)
1.0≦SB≦3.0 Formula (2b)
where SP represents a substitution degree of hydroxyl groups of the cellulose for a propionyl group, and SB represents a substitution degree of hydroxyl groups of the cellulose for a butyryl group.

14. The method for saponification of cellulose acylate film according to claim 13, wherein the saponification is conducted by dipping the cellulose acylate film in the saponifying solution which convects at a linear speed of 1 m/min or more.

15. The method for saponification of cellulose acylate film according to claim 13, wherein a difference between a temperature of the saponifying solution at the beginning of the saponification of the cellulose acylate film and a temperature of the saponifying solution after completion of the saponification of the cellulose acylate film is 0.1° C. or more.

16. The method for saponification of cellulose acylate film according to claim 13, wherein the saponifying solution comprises an organic solvent.

17. The method for saponification of cellulose acylate film according to claim 16, wherein the organic solvent is a glycol.

18-20. (canceled)

21. A method for producing a cellulose acylate film which comprises conducting the method according to claim 13.

22. A cellulose acylate film produced by the method according to claim 21.
